(19) United States
(12) Patent Application Publication
(10) Pub. No.: US 2024/0319322 A1
(43) Pub. Date: Sep. 26, 2024

(54) JOINT RADIO FREQUENCY (RF) SENSING AND ENERGY HARVESTING

(71) Applicant: QUALCOMM Incorporated, San Diego, CA (US)

(72) Inventors: Weimin DUAN, San Diego, CA (US); Huilin XU, Temecula, CA (US); Kangqi LIU, San Diego, CA (US); Fei HUANG, San Diego, CA (US)

(21) Appl. No.: 18/190,038

(22) Filed: Mar. 24, 2023

(51) Int. Cl. G01S 7/02; G01S 7/00; H04L 5/00

(52) U.S. Cl. CPC G01S 7/023; G01S 7/006; H04L 5/0005; H04L 5/0048

(57) ABSTRACT

Disclosed are systems, apparatuses, processes, and computer-readable media for wireless communications. For example, a network entity for wireless communications can receive a sensing reference signal reflected from a target. The network entity can detect and measure remote interference (RI) based on the sensing reference signal.

### FIELD OF THE DISCLOSURE

The present disclosure generally relates to scheduling and/or processing sensing and communication signals for joint communications and sensing (JCS). For example, aspects of the present disclosure relate to joint radio frequency (RF) sensing and energy harvesting.

### BACKGROUND OF THE DISCLOSURE

Wireless communications systems are widely deployed to provide various types of communication content, such as voice, video, packet data, messaging, and broadcast. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE). Some wireless communications systems may support communications between UEs, which may involve direct transmissions between two or more UEs.

Due to larger bandwidths being allocated for wireless cellular communications systems (e.g., including 5G and 5G beyond) and more use cases being introduced into the cellular communications systems, joint RF sensing and energy harvesting can be an essential feature for existing or future wireless communication systems, such as to enhance the overall spectral efficiency of the wireless communication networks.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Systems and techniques are described for wireless communications. According to at least one example, a first network entity for wireless communications is provided. The first network entity includes at least one memory and at least one processor coupled to the at least one memory and configured to: receive a sensing reference signal reflected from a target; and detecting and measure remote interference (RI) based on the sensing reference signal.

In another illustrative example, a method for wireless communications at a first network entity is provided. The method includes: receiving, by the first network entity, a sensing reference signal reflected from a target; and detecting and measuring, by the first network entity, remote interference (RI) based on the sensing reference signal.

In another illustrative example, a non-transitory computer-readable medium having stored thereon instructions that, when executed by at least one processor, cause the at least one processor to: receive a sensing reference signal reflected from a target; and detecting and measure remote interference (RI) based on the sensing reference signal.

In another illustrative example, an apparatus for wireless communications is provided. The apparatus includes: means for receiving a sensing reference signal reflected from a target; and means for detecting and measuring remote interference (RI) based on the sensing reference signal.

In another illustrative example, a network device for wireless communications is provided. The network device includes at least one memory and at least one processor coupled to the at least one memory and configured to: transmit a sensing reference signal towards a target; and adjust a power of the sensing reference signal based on measurements of remote interference (RI) from the sensing reference signal.

In another illustrative example, a method for wireless communications at a first network entity is provided. The method includes: transmitting, by the network entity, a sensing reference signal towards a target; and adjusting, by the network entity, a power of the sensing reference signal based on measurements of remote interference (RI) from the sensing reference signal.

In another illustrative example, a non-transitory computer-readable medium having stored thereon instructions that, when executed by at least one processor, cause the at least one processor to: transmit a sensing reference signal towards a target; and adjust a power of the sensing reference signal based on measurements of remote interference (RI) from the sensing reference signal.

In another illustrative example, an apparatus for wireless communications is provided. The apparatus includes: means for transmitting a sensing reference signal towards a target; and means for adjusting a power of the sensing reference signal based on measurements of remote interference (RI) from the sensing reference signal.

In some aspects, one or more of the network devices, apparatus, or other devices described herein is, is part of, and/or includes a user equipment (UE), a base station (e.g., a gNodeB (gNB), an eNodeB (eNB), etc.), or a portion of a base station (e.g., one or more of a central unit (CU), a distributed unit (DU), a radio unit (RU), a Near-Real Time (Near-RT) RAN Intelligent Controller (RIC), or a Non-Real Time (Non-RT) RIC of the base station). The UE may be a wearable device, an extended reality (XR) device (e.g., a virtual reality (VR) device, an augmented reality (AR) device, or a mixed reality (MR) device), a head-mounted display (HMD) device, a wireless communication device, a mobile device (e.g., a mobile telephone and/or mobile handset and/or so-called “smart phone” or other mobile device), a camera, a personal computer, a laptop computer, a server computer, a vehicle or a computing device or component of a vehicle, another device, or a combination thereof. In some aspects, the one or more of the network devices, apparatus, or other devices may include a camera or multiple cameras for capturing one or more images. In some examples, the one or more of the network devices, apparatus, or other devices may further include a display for displaying one or more images, notifications, and/or other displayable data. In some cases, the one or more of the network devices, apparatus, or other devices may include one or more receivers, transmitters, or transceivers for receiving and/or transmitting wireless communications.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof.

FIG. 1 is a diagram illustrating an example wireless communications system, which may be employed by the disclosed systems and techniques for joint radio frequency (RF) sensing and energy harvesting, in accordance with some aspects of the present disclosure.

FIG. 2 is a diagram illustrating an example of a disaggregated base station architecture, which may be employed by the disclosed systems and techniques for joint RF sensing and energy harvesting, in accordance with some aspects of the present disclosure.

FIG. 3 is a diagram illustrating an example of a frame structure, which may be employed by the disclosed systems and techniques for joint RF sensing and energy harvesting, in accordance with some aspects of the present disclosure.

FIG. 4 is a block diagram illustrating an example of a computing system of an electronic device that may be employed by the disclosed systems and techniques for joint RF sensing and energy harvesting, in accordance with some aspects of the present disclosure.

FIG. 5 is a diagram illustrating an example of a wireless device utilizing RF monostatic sensing techniques, which may be employed by the disclosed systems and techniques described herein to determine one or more characteristics of a target object, in accordance with some aspects of the present disclosure.

FIG. 6 is a diagram illustrating an example of a receiver utilizing RF bistatic sensing techniques with one transmitter, which may be employed by the disclosed systems and techniques described herein to determine one or more characteristics of a target object, in accordance with some aspects of the present disclosure.

FIG. 7 is a diagram illustrating an example of a receiver utilizing RF bistatic sensing techniques with multiple transmitters, which may be employed by the disclosed systems and techniques described herein to determine one or more characteristics of a target object, in accordance with some aspects of the present disclosure.

FIG. 8 is a diagram illustrating an example geometry for bistatic (or monostatic) sensing, in accordance with some aspects of the present disclosure.

FIG. 9 is a diagram illustrating a bistatic range of bistatic sensing, in accordance with some aspects of the present disclosure.

FIG. 10 is a diagram illustrating an example of devices involved in wireless communications (e.g., sidelink communications), in accordance with some aspects of the present disclosure.

FIG. 11 is a diagram illustrating examples of existing comb structures for reference signals.

FIG. 12 is a diagram illustrating an example of a system for joint RF sensing and energy harvesting, where the system is performing bistatic sensing of a target, in accordance with some aspects of the present disclosure.

FIG. 13 is a diagram illustrating an example of a system for joint RF sensing and energy harvesting, where the system is detecting a target, in accordance with some aspects of the present disclosure.

FIG. 14 is a diagram illustrating an example of a system for joint RF sensing and energy harvesting, where the system is tracking a target and performing energy harvesting, in accordance with some aspects of the present disclosure.

FIG. 15 is a diagram illustrating an example of a system for joint RF sensing and energy harvesting, where a target is located outside of a sensing coverage area of a base station of the system, in accordance with some aspects of the present disclosure.

FIG. 16 is a diagram illustrating an example of a system for joint RF sensing and energy harvesting, where the system includes multiple sensing base stations sensing a target, in accordance with some aspects of the present disclosure.

FIG. 17 is a flow chart illustrating an example of a process for wireless communications utilizing methods for joint RF sensing and energy harvesting, in accordance with some aspects of the present disclosure.

FIG. 18 is a flow chart illustrating another example of a process for wireless communications utilizing methods for joint RF sensing and energy harvesting, in accordance with some aspects of the present disclosure.

FIG. 19 is a flow chart illustrating another example of a process for wireless communications utilizing methods for joint RF sensing and energy harvesting, in accordance with some aspects of the present disclosure.

FIG. 20 is a flow chart illustrating another example of a process for wireless communications utilizing methods for joint RF sensing and energy harvesting, in accordance with some aspects of the present disclosure.

FIG. 21 is a block diagram illustrating an example of a computing system, which may be employed by the disclosed systems and techniques for joint RF sensing and energy harvesting, in accordance with some aspects of the present disclosure.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Radar sensing systems use radio frequency (RF) waveforms to perform RF sensing to determine or estimate one or more characteristics of a target object, such as the distance, angle, and/or velocity of the target object. A target object may include a vehicle, an obstruction, a user, a building, or other object. A typical radar system includes at least one transmitter, at least one receiver, and at least one processor. A radar sensing system may perform monostatic sensing when one receiver is employed that is co-located with a transmitter. A radar system may perform bistatic sensing when one receiver of a first device is employed that is located remote from a transmitter of a second device. Similarly, a radar system may perform multi-static sensing when multiple receivers of multiple devices are employed that are all located remotely from at least one transmitter of at least one device.

During operation of a radar sensing system, a transmitter transmits an electromagnetic (EM) signal in the RF domain towards a target object. The signal reflects off of the target object to produce one or more reflection signals, which provides information or properties regarding the target, such as target object's location and speed. At least one receiver receives the one or more reflection signals and at least one processor, which may be associated with at least one receiver, utilizes the information from the one or more reflection signals to determine information or properties of the target object. A target object can also be referred herein as a target.

Generally, RF sensing involves monitoring moving targets with different motions (e.g., a moving car or pedestrian, a body motion of a person, such as breathing, and/or other micro-motions related to a target). Doppler, which measures the phase variation in a signal and is indicative of motion, is an important characteristic for sensing of a target.

In some cases, the radar sensing signals, which can be referred to as radar reference signals (RSs), such as sensing reference signals (S-RS), may be designed for and used for sensing purposes. Radar RSs do not contain any communications information. Conversely, communication RSs, such as demodulation reference signals (DMRSs), are typically designed for and solely used for communications purposes, such as estimating channel parameters for communications.

Cellular communications systems are designed to transmit communication signals on designated communication frequency bands (e.g., 23 gigahertz (GHz), 3.5 GHz, etc. for 5G/NR, 2.2 GHz for LTE, among others). RF sensing systems are designed to transmit RF sensing signals on designated radar RF frequency bands (e.g., 77 GHz for autonomous driving).

Unmanned aerial vehicles (UAVs) are currently employed for many use cases. Release 17 (Rel-17) of 3GPP has both a system aspect 2 (SA2) study item and a SA2 work item for UAVs. However, Rel-17 does not have any radio access network (RAN) components for UAVs. The scope of work involving UAVs, which is across both SA2 and RAN2, includes UAV authentication and authorization, identification (e.g., to support aviation regulations for broadcast remote identification), and UAV location and tracking.

Currently, UAV location and tracking can support multiple different models. For example, one model involves UAV reporting, which may be based on a request from a UE-specific search space (USS). For this model, the 3GPP system can provide the UAV location. Another model involves periodic UAV location reporting, which can be based on a request from the USS. For this model, the 3GPP system can periodically provide the UAV location, based on an interval that can be negotiated between the USS and the 3GPP system. For another model, the UAV presence within a monitoring area (e.g., moving inside or outside of the monitoring area) can be monitored, and a monitoring report can be provided to the USS. In some cases, in order to receive the reporting of the UE presence within the monitoring area, the USS can subscribe for event monitoring for a specific UAV by providing an “area of interest.” The 3GPP system may map the “area of interest” to 3GPP specific areas (e.g., cells), or may use the actual location based on 3GPP gateway mobile location center (GMLC) reporting. Another example model involves UAV discovery. For this model, the USS may provide an “area of interest,” and may receive from the 3GPP system, a listing of UAVs that are served by the 3GPP system and present within that specific area.

As one use case. UAVs are often used as delivery platforms for delivery of parcels. The UAVs may be implemented as UEs, such as drones. In some cases, the UAVs are in communication with base stations, such as gNBs. UAV performance as a delivery platform often involves weighting tradeoffs between the distance traveled by the UAV and the package weight carried by the UAV. The delivery distance may be limited due to the battery size of the UAV as well as the weight of the package carried by the UAV. For example, for a given delivery distance guarantee, there can be a maximum weight of the package allowed for delivery by the UAV. For another example, for a given weight of the package to be delivered, there can be a maximum delivery distance allowed for delivery by the UAV. There may be some use cases where the range of the UAV delivery distance may need to be extended such that the UAV does not need to stop, during its delivery, to charge its battery.

In some use cases, a base station (e.g., a gNB), or other network entity, may perform RF sensing to monitor locations of UAVs, such as by performing cellular-based wide area RF sensing. During the monitoring (e.g., sensing), the UAV may move (e.g., fly) through many cells, from one cell to another cell, to travel for a long distance. For wide-area RF sensing, a base station (e.g., gNB) can transmit with a high power (e.g., a power higher than the power used for communications) to meet the link budget requirements for the sensing. The transmission power for RF sensing by a base station (e.g., a gNB) can be increased by employing a narrower beamwidth for the transmission beam for the sensing. These high-power sensing beams present an opportunity for a UAV to harvest energy from the base station transmitted sensing signals to improve the distance and/or weight capability of the UAV.

In some aspects of the present disclosure, systems, apparatuses, methods (also referred to as processes), and computer-readable media (collectively referred to herein as “systems and techniques”) are described herein that provide joint RF sensing and energy harvesting (EH). The joint RF sensing and energy and harvesting techniques can be used for one or more use cases, such as for UAV use cases. For example, the systems and techniques can reuse RF sensing waveforms (e.g., transmitted by base stations) for energy harvesting purposes (e.g., for energy harvesting by UAVs or other devices). As such, the RF sensing waveforms can be utilized for both sensing purposes and energy harvesting purposes. By allowing for a device (e.g., a UAV, an electric vehicle, etc.) to harvest energy from sensing signals transmitted by a network device (e.g., a base station or other network device), the device can stay powered for a longer period of time. Using a UAV as an illustrative use case, by allowing for a UAV to harvest energy from sensing signals transmitted by a network device (e.g., a base station), delivery service by the UAV can be enhanced by providing for longer delivery distances and/or for delivering of heavier packages.

There are several advantages for devices (e.g., UAVs, electric vehicles, etc.) or other devices) employing EH sensing techniques (e.g., energy harvesting from RF sensing signals) versus typical EH communication techniques (e.g., energy harvesting from RF communication signals). For example, for EH sensing techniques, a high-power sensing signal is employed. A device trajectory (e.g., a UAV trajectory) can be easier to predict (e.g., by the network, such as a network service) when there low multipath and a strong Doppler signature (e.g., from the high-power sensing signal). The prediction of the device (e.g., UAV) trajectory can allow for a more efficient energy harvesting operation and RF sensing operation. For another example, if base stations (e.g., gNBs) exchange UAV trajectory information with each other (e.g., for seamless switching from one gNB to another, such as when the UAV exists in the coverage of a first gNB and enters a coverage area of a second gNB), the information may also include the altitude, which can be unique to the UAV. Another example is that a base station's (e.g., gNB's) transmission power for RF sensing can be higher than the transmission power for regular communication transmissions. The higher transmission power for RF sensing can be beneficial for the EH sensing techniques. For tracking a target device (e.g., a UAV) after the detection of the target, the sensing beam beamwidth could be narrower (e.g., narrower than the beamwidth of the initial sensing beam used to detect the target) to provide for additional power gain for the EH of the target device.

In one or more aspects, there may be several EH sensing scenarios. For example, for one scenario, joint RF sensing and EH may be employed for a purely passive device (e.g., a passive UAV), which can be defined to be a device that relies on an over-the-air (OTA) based method for the joint RF sensing and EH. Since the device (e.g., UAV) is purely passive, the device may not be in communication with the base station (e.g., gNB). For another scenario, joint RF sensing and EH may be employed for a device (e.g., UAV) equipped with a UE. For this scenario, the overall efficiency of the joint RF sensing and EH operation can be enhanced by information sharing between the device (e.g., UAV) and the network, such as a network server.

In one or more examples, an issue of remote interference (RI) may occur due to the base station's (e.g., gNB's) higher transmission power and potential antenna pointing towards the sky. In some cases, the high power transmission can create RI. Typically, a base station antenna points towards the ground. For the joint sensing and EH, the base station may point (e.g., beamform) its antenna in the sky (e.g., point towards a UAV in the sky). The pointing of the antenna towards the sky, instead of towards the ground, can lead to an increase in interference power. In one or more aspects, the systems and techniques provide solutions for the issue of RI. In one or more examples, the remote interference measurement can be reused to enhance the system efficiency.

Additional aspects of the present disclosure are described in more detail below.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

A network entity can be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity” or “base station” (e.g., with an aggregated/monolithic base station architecture or disaggregated base station architecture) may refer to a single physical Transmission-Reception Point (TRP) or to multiple physical Transmission-Reception Points (TRPs) that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An RF signal includes an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

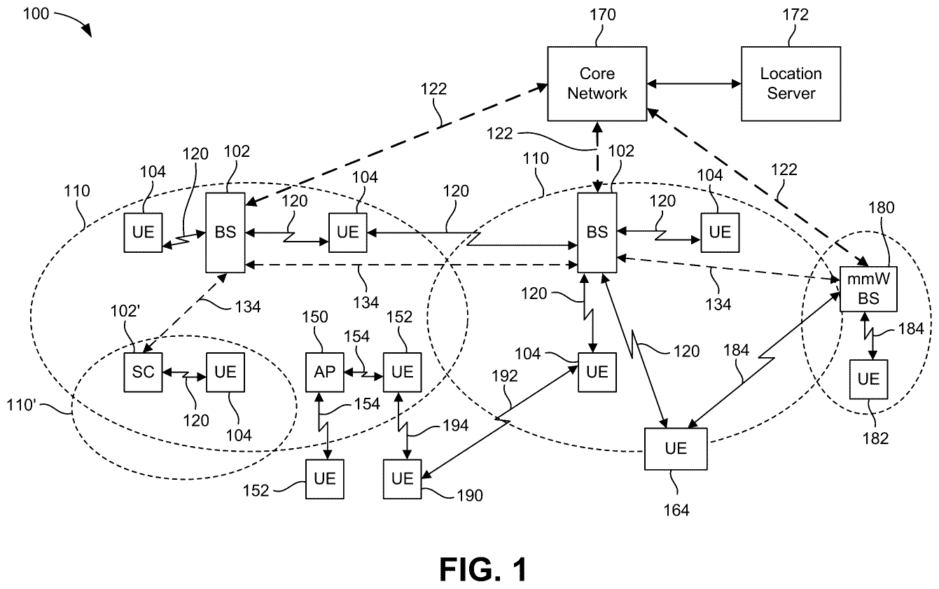

According to various aspects, FIG. 1 illustrates an exemplary wireless communications system 100, which may be employed by the disclosed systems and techniques described herein for joint RF sensing and energy harvesting for UAV use cases. The wireless communications system 100 (which may also be referred to as a wireless wide area network (WWAN)) can include various base stations 102 and various UEs 104. In some aspects, the base stations 102 may also be referred to as “network entities” or “network nodes.” One or more of the base stations 102 can be implemented in an aggregated or monolithic base station architecture. Additionally or alternatively, one or more of the base stations 102 can be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 can include macro cell base stations (high power cellular base stations) and/or small cell base stations (low power cellular base stations). In an aspect, the macro cell base station may include eNBs and/or ng-eNBs where the wireless communications system 100 corresponds to a long term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 can include devices (e.g., UEs, etc.) that communicate with one or more UEs 104, base stations 102, APs 150, etc. utilizing the ultra-wideband (UWB) spectrum. The UWB spectrum can range from 3.1 to 10.5 GHZ.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHZ and a wavelength between 1 millimeter and 10 millimeters. Radio waves in this band may be referred to as a millimeter wave. Near mmW may extend down to a frequency of 3 GHZ with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node or entity (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while canceling to suppress radiation in undesired directions.

Transmit beams may be quasi-collocated, meaning that they appear to the receiver (e.g., a UE) as having the same parameters, regardless of whether or not the transmitting antennas of the network node themselves are physically collocated. In NR, there are four types of quasi-collocation (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receiving beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain of other beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Receive beams may be spatially related. A spatial relation means that parameters for a transmit beam for a second reference signal can be derived from information about a receive beam for a first reference signal. For example, a UE may use a particular receive beam to receive one or more reference downlink reference signals (e.g., positioning reference signals (PRS), tracking reference signals (TRS), phase tracking reference signal (PTRS), cell-specific reference signals (CRS), channel state information reference signals (CSI-RS), primary synchronization signals (PSS), secondary synchronization signals (SSS), synchronization signal blocks (SSBs), etc.) from a network node or entity (e.g., a base station). The UE can then form a transmit beam for sending one or more uplink reference signals (e.g., uplink positioning reference signals (UL-PRS), sounding reference signal (SRS), demodulation reference signals (DMRS), PTRS, etc.) to that network node or entity (e.g., a base station) based on the parameters of the receive beam.

Note that a “downlink” beam may be either a transmit beam or a receive beam, depending on the entity forming it. For example, if a network node or entity (e.g., a base station) is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a network node or entity (e.g., a base station) is forming the uplink beam, it is an uplink receive beam, and if a UE is forming the uplink beam, it is an uplink transmit beam.

In 5G, the frequency spectrum in which wireless network nodes or entities (e.g., base stations 102/180, UEs 104/182) operate is divided into multiple frequency ranges, FR1 (from 450 to 6000 Megahertz (MHz)), FR2 (from 24250 to 52600 MHZ), FR3 (above 52600 MHZ), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (x component carriers) for transmission in each direction. The component carriers may or may not be adjacent to each other on the frequency spectrum. Allocation of carriers may be asymmetric with respect to the downlink and uplink (e.g., more or less carriers may be allocated for downlink than for uplink). The simultaneous transmission and/or reception of multiple carriers enables the UE 104/182 to significantly increase its data transmission and/or reception rates. For example, two 20 MHZ aggregated carriers in a multi-carrier system would theoretically lead to a two-fold increase in data rate (i.e., 40 MHz), compared to that attained by a single 20 MHz carrier.

In order to operate on multiple carrier frequencies, a base station 102 and/or a UE 104 is equipped with multiple receivers and/or transmitters. For example, a UE 104 may have two receivers, “Receiver 1” and “Receiver 2,” where “Receiver 1” is a multi-band receiver that can be tuned to band (i.e., carrier frequency) ‘X’ or band ‘Y,’ and “Receiver 2” is a one-band receiver tuneable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (an SCell) in order to measure band ‘Y’ (and vice versa). In contrast, whether the UE 104 is being served in band ‘X’ or band ‘Y,’ because of the separate “Receiver 2,” the UE 104 can measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on. As noted above, UE 104 and UE 190 can be configured to communicate using sidelink communications. In some cases, a sidelink transmission can include a request for feedback (e.g., a hybrid automatic repeat request (HARQ)) from the receiving UE.

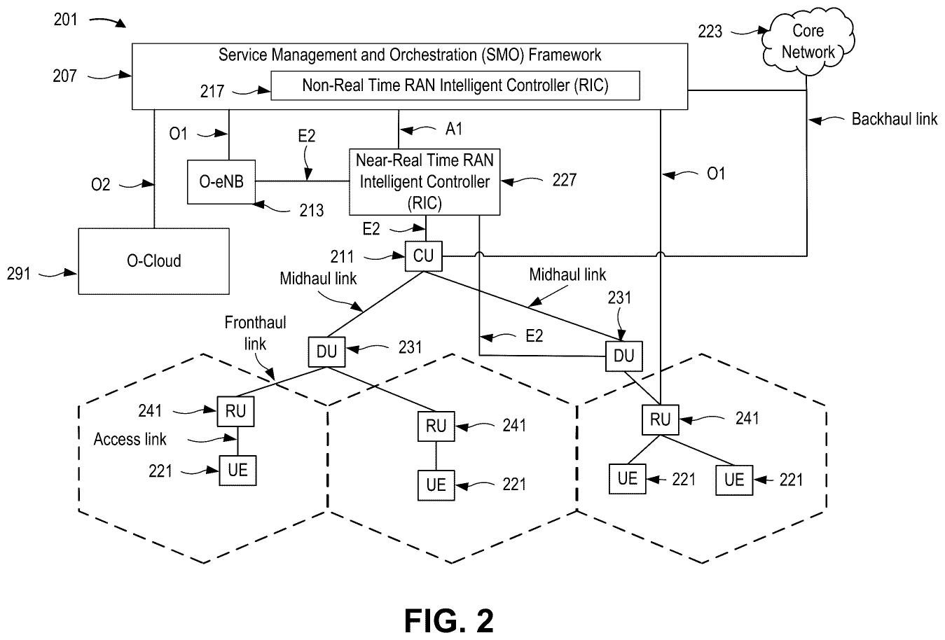

FIG. 2 is a diagram illustrating an example of a disaggregated base station architecture, which may be employed by the disclosed systems and techniques for joint RF sensing and energy harvesting for UAV use cases. Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, AP, a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

As previously mentioned, FIG. 2 shows a diagram illustrating an example disaggregated base station 201 architecture. The disaggregated base station 201 architecture may include one or more central units (CUs) 211 that can communicate directly with a core network 223 via a backhaul link, or indirectly with the core network 223 through one or more disaggregated base station units (such as a Near-Real Time (Near-RT) RAN Intelligent Controller (RIC) 227 via an E2 link, or a Non-Real Time (Non-RT) RIC 217 associated with a Service Management and Orchestration (SMO) Framework 207, or both). A CU 211 may communicate with one or more distributed units (DUs) 231 via respective midhaul links, such as an F1 interface. The DUs 231 may communicate with one or more radio units (RUs) 241 via respective fronthaul links. The RUs 241 may communicate with respective UEs 221 via one or more RF access links. In some implementations, the UE 221 may be simultaneously served by multiple RUs 241.

Each of the units, i.e., the CUS 211, the DUs 231, the RUs 241, as well as the Near-RT RICs 227, the Non-RT RICs 217 and the SMO Framework 207, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 211 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 211. The CU 211 may be configured to handle user plane functionality (i.e., Central Unit-User Plane (CU-UP)), control plane functionality (i.e., Central Unit-Control Plane (CU-CP)), or a combination thereof. In some implementations, the CU 211 can be logically split into one or more CU-UP units and one or more CU-CP units. The CU-UP unit can communicate bidirectionally with the CU-CP unit via an interface, such as the E1 interface when implemented in an O-RAN configuration. The CU 211 can be implemented to communicate with the DU 231, as necessary, for network control and signaling.

The DU 231 may correspond to a logical unit that includes one or more base station functions to control the operation of one or more RUs 241. In some aspects, the DU 231 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 231 may further host one or more low PHY layers. Each layer (or module) can be implemented with an interface configured to communicate signals with other layers (and modules) hosted by the DU 231, or with the control functions hosted by the CU 211.

Lower-layer functionality can be implemented by one or more RUs 241. In some deployments, an RU 241, controlled by a DU 231, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 241 can be implemented to handle over the air (OTA) communication with one or more UEs 221. In some implementations, real-time and non-real-time aspects of control and user plane communication with the RU(s) 241 can be controlled by the corresponding DU 231. In some scenarios, this configuration can enable the DU(s) 231 and the CU 211 to be implemented in a cloud-based RAN architecture, such as a vRAN architecture.

The SMO Framework 207 may be configured to support RAN deployment and provisioning of non-virtualized and virtualized network elements. For non-virtualized network elements, the SMO Framework 207 may be configured to support the deployment of dedicated physical resources for RAN coverage requirements which may be managed via an operations and maintenance interface (such as an O1 interface). For virtualized network elements, the SMO Framework 207 may be configured to interact with a cloud computing platform (such as an open cloud (O-Cloud) 291) to perform network element life cycle management (such as to instantiate virtualized network elements) via a cloud computing platform interface (such as an O2 interface). Such virtualized network elements can include, but are not limited to, CUs 211, DUs 231, RUS 241 and Near-RT RICs 227. In some implementations, the SMO Framework 207 can communicate with a hardware aspect of a 4G RAN, such as an open eNB (O-cNB) 213, via an O1 interface. Additionally, in some implementations, the SMO Framework 207 can communicate directly with one or more RUs 241 via an O1 interface. The SMO Framework 207 also may include a Non-RT RIC 217 configured to support functionality of the SMO Framework 207.

The Non-RT RIC 217 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 227. The Non-RT RIC 217 may be coupled to or communicate with (such as via an A1 interface) the Near-RT RIC 227. The Near-RT RIC 227 may be configured to include a logical function that enables near-real-time control and optimization of RAN elements and resources via data collection and actions over an interface (such as via an E2 interface) connecting one or more CUs 211, one or more DUs 231, or both, as well as an O-cNB 213, with the Near-RT RIC 227.

In some implementations, to generate AI/ML models to be deployed in the Near-RT RIC 227, the Non-RT RIC 217 may receive parameters or external enrichment information from external servers. Such information may be utilized by the Near-RT RIC 227 and may be received at the SMO Framework 207 or the Non-RT RIC 217 from non-network data sources or from network functions. In some examples, the Non-RT RIC 217 or the Near-RT RIC 227 may be configured to tune RAN behavior or performance. For example, the Non-RT RIC 217 may monitor long-term trends and patterns for performance and employ AI/ML models to perform corrective actions through the SMO Framework 207 (such as reconfiguration via 01) or via creation of RAN management policies (such as A1 policies).

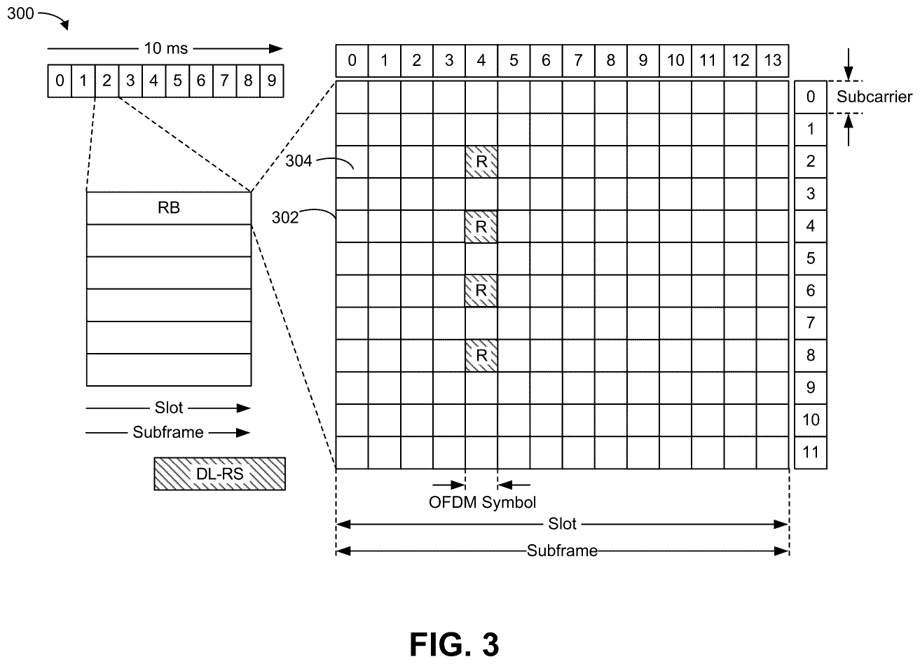

Various radio frame structures may be used to support downlink, uplink, and sidelink transmissions between network nodes (e.g., base stations and UEs). FIG. 3 is a diagram 300 illustrating an example of a frame structure, which may be employed by the disclosed systems and techniques for joint RF sensing and energy harvesting for UAV use cases. Other wireless communications technologies may have different frame structures and/or different channels.

NR (and LTE) utilizes OFDM on the downlink and single-carrier frequency division multiplexing (SC-FDM) on the uplink. Unlike LTE, however, NR has an option to use OFDM on the uplink as well. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (resource block) may be 12 subcarriers (or 180 kHz). Consequently, the nominal fast Fourier transform (FFT) size may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10, or 20 MHz, respectively.

LTE supports a single numerology (subcarrier spacing, symbol length, etc.). In contrast, NR may support multiple numerologies (u). For example, subcarrier spacing (SCS) of 15 kHz, 30 kHz, 60 kHz, 120 kHz, and 240 kHz or greater may be available. Table 1 provided below lists some various parameters for different NR numerologies.

TABLE 1

| | | | | | | | Max. |
|---|---|---|---|---|---|---|---|
| | | | | | | | nominal |
| | | | | | Slot | Symbol | system BW |
| | SCS | Symbols/ | Slots/ | Slots/ | Duration | Duration | (MHz) with |
| | (kHz) | Sot | Subframe | Frame | (ms) | (μs) | 4 K FFT size |
| 0 | 15 | 14 | 1 | 10 | 1 | 66.7 | 50 |
| 1 | 30 | 14 | 2 | 20 | 0.5 | 33.3 | 100 |
| 2 | 60 | 14 | 4 | 40 | 0.25 | 16.7 | 100 |
| 3 | 120 | 14 | 8 | 80 | 0.125 | 8.33 | 400 |
| 4 | 240 | 14 | 16 | 160 | 0.0625 | 4.17 | 800 |

In one example, a numerology of 15 kHz is used. Thus, in the time domain, a 10 millisecond (ms) frame is divided into 10 equally sized subframes of 1 ms each, and each subframe includes one time slot. In FIG. 3, time is represented horizontally (e.g., on the X axis) with time increasing from left to right, while frequency is represented vertically (e.g., on the Y axis) with frequency increasing (or decreasing) from bottom to top.

A resource grid may be used to represent time slots, each time slot including one or more time-concurrent resource blocks (RBs) (also referred to as physical RBs (PRBs)) in the frequency domain. FIG. 3 illustrates an example of a resource block (RB) 302. Data or information for joint communications and sensing may be included in one or more RBs 302. The RB 302 is arranged with the time domain on the horizontal (or x-) axis and the frequency domain on the vertical (or y-) axis. As shown, the RB 302 may be 180 kilohertz (kHz) wide in frequency and one slot long in time (with a slot being 1 milliseconds (ms) in time). In some cases, the slot may include fourteen symbols (e.g., in a slot configuration 0). The RB 302 includes twelve subcarriers (along the y-axis) and fourteen symbols (along the x-axis).

An intersection of a symbol and subcarrier can be referred to as a resource element (RE) 304 or tone. The RB 302 of FIG. 3 includes multiple REs, including the resource element (RE) 304. For instance, a RE 304 is 1 subcarrier x 1 symbol (e.g., OFDM symbol), and is the smallest discrete part of the subframe. A RE 304 includes a single complex value representing data from a physical channel or signal. The number of bits carried by each RE 304 depends on the modulation scheme.

In some aspects, some REs 304 can be used to transmit downlink reference (pilot) signals (DL-RS). The DL-RS can include Positioning Reference Signal (PRS), Tracking Reference Signal (TRS), Phase Tracking Reference Signal (PTRS), Channel State Information Reference Signal (CSI-RS), Demodulation Reference Signal (DMRS), Primary Synchronization Signal (PSS), Secondary Synchronization Signal (SSS), etc. The resource grid if FIG. 3 illustrates exemplary locations of REs 304 used to transmit DL-RS (labeled “R”).

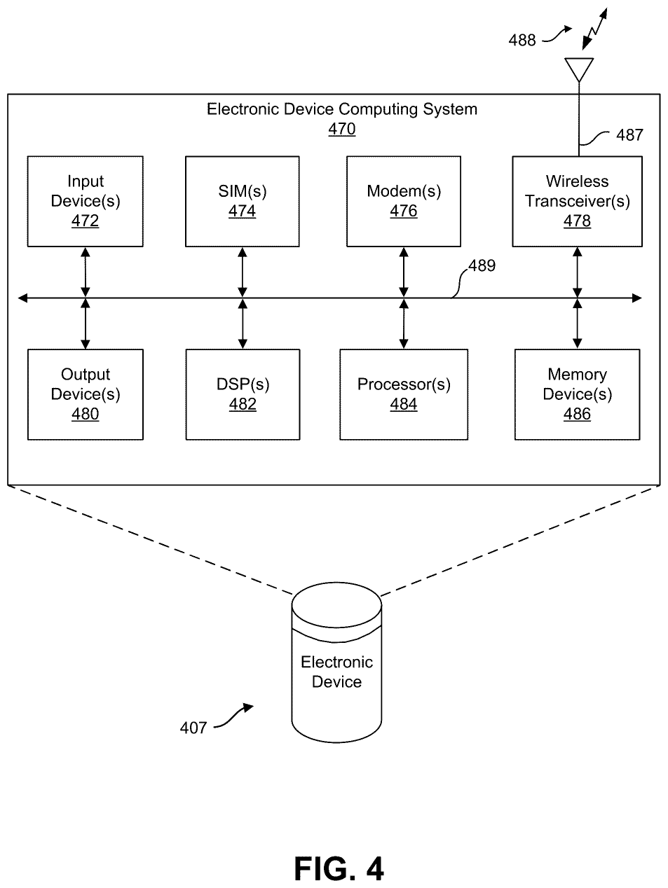

FIG. 4 is a block diagram illustrating an example of a computing system 470 of an electronic device 407, which may be employed by the disclosed systems and techniques for joint RF sensing and energy harvesting for UAV use cases. The electronic device 407 is an example of a device that can include hardware and software for the purpose of connecting and exchanging data with other devices and systems using a communications network (e.g., a 3^{rd} Generation Partnership network, such as a 5^{th} Generation (5G)/New Radio (NR) network, a 4^{th} Generation (4G)/Long Term Evolution (LTE) network, a WiFi network, or other communications network). For example, the electronic device 407 can include, or be a part of, a mobile device (e.g., a mobile telephone), a wearable device (e.g., a network-connected or smart watch), an extended reality device (e.g., a virtual reality (VR) device, an augmented reality (AR) device, or a mixed reality (MR) device), a personal computer, a laptop computer, a tablet computer, an Internet-of-Things (IoT) device, a wireless access point, a router, a vehicle or component of a vehicle, a server computer, a robotics device, and/or other device used by a user to communicate over a wireless communications network. In some cases, the device 407 can be referred to as user equipment (UE), such as when referring to a device configured to communicate using 5G/NR, 4G/LTE, or other telecommunication standard. In some cases, the device can be referred to as a station (STA), such as when referring to a device configured to communicate using the Wi-Fi standard.

The computing system 470 includes software and hardware components that can be electrically or communicatively coupled via a bus 489 (or may otherwise be in communication, as appropriate). For example, the computing system 470 includes one or more processors 484. The one or more processors 484 can include one or more CPUs, ASICS, FPGAs, APs, GPUs, VPUs, NSPs, microcontrollers, dedicated hardware, any combination thereof, and/or other processing device/s and/or system/s. The bus 489 can be used by the one or more processors 484 to communicate between cores and/or with the one or more memory devices 486.

The computing system 470 may also include one or more memory devices 486, one or more digital signal processors (DSPs) 482, one or more subscriber identity modules (SIMs) 474, one or more modems 476, one or more wireless transceivers 478, one or more antennas 487, one or more input devices 472 (e.g., a camera, a mouse, a keyboard, a touch sensitive screen, a touch pad, a keypad, a microphone or a microphone array, and/or the like), and one or more output devices 480 (e.g., a display, a speaker, a printer, and/or the like).

The one or more wireless transceivers 478 can receive wireless signals (e.g., signal 488) via antenna 487 from one or more other devices, such as other user devices, network devices (e.g., base stations such as evolved Node Bs (eNBs) and/or gNodeBs (gNBs), WiFi access points (APs) such as routers, range extenders or the like, etc.), cloud networks, and/or the like. In some examples, the computing system 470 can include multiple antennas or an antenna array that can facilitate simultaneous transmit and receive functionality. Antenna 487 can be an omnidirectional antenna such that RF signals can be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a WiFi network), a Bluetooth™ network, and/or other network. In some examples, the one or more wireless transceivers 478 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end can generally handle selection and conversion of the wireless signals 488 into a baseband or intermediate frequency and can convert the RF signals to the digital domain.

In some cases, the computing system 470 can include a coding-decoding device (or CODEC) configured to encode and/or decode data transmitted and/or received using the one or more wireless transceivers 478. In some cases, the computing system 470 can include an encryption-decryption device or component configured to encrypt and/or decrypt data (e.g., according to the Advanced Encryption Standard (AES) and/or Data Encryption Standard (DES) standard) transmitted and/or received by the one or more wireless transceivers 478.

The one or more SIMs 474 can each securely store an international mobile subscriber identity (IMSI) number and related key assigned to the user of the electronic device 407. The IMSI and key can be used to identify and authenticate the subscriber when accessing a network provided by a network service provider or operator associated with the one or more SIMs 474. The one or more modems 476 can modulate one or more signals to encode information for transmission using the one or more wireless transceivers 478. The one or more modems 476 can also demodulate signals received by the one or more wireless transceivers 478 in order to decode the transmitted information. In some examples, the one or more modems 476 can include a WiFi modem, a 4G (or LTE) modem, a 5G (or NR) modem, and/or other types of modems. The one or more modems 476 and the one or more wireless transceivers 478 can be used for communicating data for the one or more SIMs 474.

The computing system 470 can also include (and/or be in communication with) one or more non-transitory machine-readable storage media or storage devices (e.g., one or more memory devices 486), which can include, without limitation, local and/or network accessible storage, a disk drive, a drive array, an optical storage device, a solid-state storage device such as a RAM and/or a ROM, which can be programmable, flash-updateable and/or the like. Such storage devices may be configured to implement any appropriate data storage, including without limitation, various file systems, database structures, and/or the like.

In various aspects, functions may be stored as one or more computer-program products (e.g., instructions or code) in memory device(s) 486 and executed by the one or more processor(s) 484 and/or the one or more DSPs 482. The computing system 470 can also include software elements (e.g., located within the one or more memory devices 486), including, for example, an operating system, device drivers, executable libraries, and/or other code, such as one or more application programs, which may comprise computer programs implementing the functions provided by various aspects, and/or may be designed to implement methods and/or configure systems, as described herein.

In some aspects, the electronic device 407 can include means for performing operations described herein. The means can include one or more of the components of the computing system 470. For example, the means for performing operations described herein may include one or more of input device(s) 472, SIM(s) 474, modems(s) 476, wireless transceiver(s) 478, output device(s) 480, DSP(s) 482, processors 484, memory device(s) 486, and/or antenna(s) 487.

In some aspects, the electronic device 407 can include means for joint RF sensing and energy harvesting for UAV use cases. In some examples, any or all of these means can include the one or more wireless transceivers 478, the one or more modems 476, the one or more processors 484, the one or more DSPs 482, the one or more memory devices 486, any combination thereof, or other component(s) of the electronic device 407.

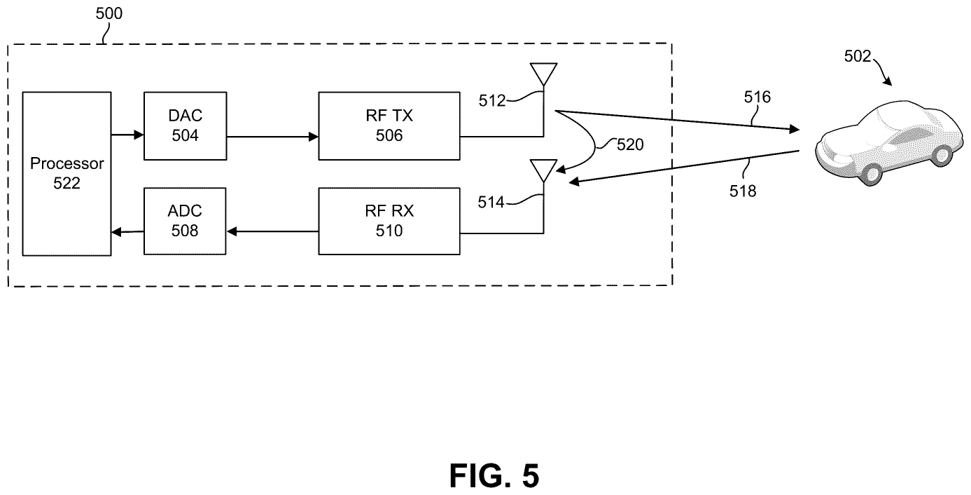

FIG. 5 is a diagram illustrating an example of a wireless device 500 utilizing RF monostatic sensing technique for determining one or more characteristics (e.g., location, speed or velocity, heading, etc.) of a target 502 object. In particular, FIG. 5 is a diagram illustrating an example of a wireless device 500 (e.g., a transmit/receive sensing node) that utilizes RF sensing techniques (e.g., monostatic sensing) to perform one or more functions, such as detecting a presence and location of a target 502 (e.g., an object, user, or vehicle), which in this figure is illustrated in the form of a vehicle.

In some examples, the wireless device 500 can be a mobile phone, a tablet computer, a wearable device, a vehicle, an extending reality (XR) device, a computing device or component of a vehicle, or other device (e.g., device 407 of FIG. 4) that includes at least one RF interface. In some examples, the wireless device 500 can be a device that provides connectivity for a user device (e.g., for electronic device 407 of FIG. 4), such as a base station (e.g., a gNB, eNB, etc.), a wireless access point (AP), or other device that includes at least one RF interface.

In some aspects, wireless device 500 can include one or more components for transmitting an RF signal. The wireless device 500 can include at least one processor 522 for generating a digital signal or waveform. The wireless device 500 can also include a digital-to-analog converter (DAC) 504 that is capable of receiving the digital signal or waveform from the processor(s) 522 (e.g., a microprocessor), and converting the digital signal or waveform to an analog waveform. The analog signal that is the output of the DAC 504 can be provided to RF transmitter 506 for transmission. The RF transmitter 506 can be a Wi-Fi transmitter, a 5G/NR transmitter, a Bluetooth™ transmitter, or any other transmitter capable of transmitting an RF signal.

RF transmitter 506 can be coupled to one or more transmitting antennas such as Tx antenna 512. In some examples, transmit (Tx) antenna 512 can be an omnidirectional antenna that is capable of transmitting an RF signal in all directions. For example, Tx antenna 512 can be an omnidirectional Wi-Fi antenna that can radiate Wi-Fi signals (e.g., 2.4 GHz. 5 GHZ, 6 GHZ, etc.) in a 360-degree radiation pattern. In another example, Tx antenna 512 can be a directional antenna that transmits an RF signal in a particular direction.

In some examples, wireless device 500 can also include one or more components for receiving an RF signal. For example, the receiver lineup in wireless device 500 can include one or more receiving antennas such as a receive (Rx) antenna 514. In some examples, Rx antenna 514 can be an omnidirectional antenna capable of receiving RF signals from multiple directions. In other examples, Rx antenna 514 can be a directional antenna that is configured to receive signals from a particular direction. In further examples, the Tx antenna 512 and/or the Rx antenna 514 can include multiple antennas (e.g., elements) configured as an antenna array (e.g., a phase antenna array).

Wireless device 500 can also include an RF receiver 510 that is coupled to Rx antenna 514. RF receiver 510 can include one or more hardware components for receiving an RF waveform such as a Wi-Fi signal, a Bluetooth™ signal, a 5G/NR signal, or any other RF signal. The output of RF receiver 510 can be coupled to an analog-to-digital converter (ADC) 508. ADC 508 can be configured to convert the received analog RF waveform into a digital waveform. The digital waveform that is the output of the ADC 508 can be provided to the processor(s) 522 for processing. The processor(s) 522 (e.g., a digital signal processor (DSP)) can be configured for processing the digital waveform.

In one example, wireless device 500 can implement RF sensing techniques, for example monostatic sensing techniques, by causing a Tx waveform 516 to be transmitted from Tx antenna 512. Although Tx waveform 516 is illustrated as a single line, in some cases, Tx waveform 516 can be transmitted in all directions by an omnidirectional Tx antenna 512. In one example, Tx waveform 516 can be a Wi-Fi waveform that is transmitted by a Wi-Fi transmitter in wireless device 500. In some cases, Tx waveform 516 can correspond to a Wi-Fi waveform that is transmitted at or near the same time as a Wi-Fi data communication signal or a Wi-Fi control function signal (e.g., a beacon transmission). In some examples, Tx waveform 516 can be transmitted using the same or a similar frequency resource as a Wi-Fi data communication signal or a Wi-Fi control function signal (e.g., a beacon transmission). In some aspects, Tx waveform 516 can correspond to a Wi-Fi waveform that is transmitted separately from a Wi-Fi data communication signal and/or a Wi-Fi control signal (e.g., Tx waveform 516 can be transmitted at different times and/or using a different frequency resource).

In some examples, Tx waveform 516 can correspond to a 5G NR waveform that is transmitted at or near the same time as a 5G NR data communication signal or a 5G NR control function signal. In some examples, Tx waveform 516 can be transmitted using the same or a similar frequency resource as a 5G NR data communication signal or a 5G NR control function signal. In some aspects, Tx waveform 516 can correspond to a 5G NR waveform that is transmitted separately from a 5G NR data communication signal and/or a 5G NR control signal (e.g., Tx waveform 516 can be transmitted at different times and/or using a different frequency resource).

In some aspects, one or more parameters associated with Tx waveform 516 can be modified that may be used to increase or decrease RF sensing resolution. The parameters may include frequency, bandwidth, number of spatial streams, the number of antennas configured to transmit Tx waveform 516, the number of antennas configured to receive a reflected RF signal (e.g., Rx waveform 518) corresponding to Tx waveform 516, the number of spatial links (e.g., number of spatial streams multiplied by number of antennas configured to receive an RF signal), the sampling rate, or any combination thereof. The transmitted waveform (e.g., Tx waveform 516) and the received waveform (e.g., Rx waveform 518) can include one or more RF sensing signals, which are also referred to as radar reference signals (RSs).

In further examples, Tx waveform 516 can be implemented to have a sequence that has perfect or almost perfect autocorrelation properties. For instance, Tx waveform 516 can include single carrier Zadoff sequences or can include symbols that are similar to orthogonal frequency-division multiplexing (OFDM) Long Training Field (LTF) symbols. In some cases, Tx waveform 516 can include a chirp signal, as used, for example, in a Frequency-Modulated Continuous-Wave (FM-CW) radar system. In some configurations, the chirp signal can include a signal in which the signal frequency increases and/or decreases periodically in a linear and/or an exponential manner.

In some aspects, wireless device 500 can implement RF sensing techniques by performing alternating transmit and receive functions (e.g., performing a half-duplex operation). For example, wireless device 500 can alternately enable its RF transmitter 506 to transmit the Tx waveform 516 when the RF receiver 510 is not enabled to receive (i.e. not receiving), and enable its RF receiver 510 to receive the Rx waveform 518 when the RF transmitter 506 is not enabled to transmit (i.e. not transmitting). When the wireless device 500 is performing a half-duplex operation, the wireless device 500 may transmit Tx waveform 516, which may be a radar RS (e.g., sensing signal).

In other aspects, wireless device 500 can implement RF sensing techniques by performing concurrent transmit and receive functions (e.g., performing a sub-band or full-band full-duplex operation). For example, wireless device 500 can enable its RF receiver 510 to receive at or near the same time as it enables RF transmitter 506 to transmit Tx waveform 516. When the wireless device 500 is performing a full-duplex operation (e.g., either sub-band full-duplex or full-band full-duplex), the wireless device 500 may transmit Tx waveform 516, which may be a radar RS (e.g., sensing signal).

In some examples, transmission of a sequence or pattern that is included in Tx waveform 516 can be repeated continuously such that the sequence is transmitted a certain number of times or for a certain duration of time. In some examples, repeating a pattern in the transmission of Tx waveform 516 can be used to avoid missing the reception of any reflected signals if RF receiver 510 is enabled after RF transmitter 506. In one example implementation, Tx waveform 516 can include a sequence having a sequence length L that is transmitted two or more times, which can allow RF receiver 510 to be enabled at a time less than or equal to L in order to receive reflections corresponding to the entire sequence without missing any information.

By implementing alternating or simultaneous transmit and receive functionality (e.g. half-duplex or full-duplex operation), wireless device 500 can receive signals that correspond to Tx waveform 516. For example, wireless device 500 can receive signals that are reflected from objects or people that are within range of Tx waveform 516, such as Rx waveform 518 reflected from target 502. Wireless device 500 can also receive leakage signals (e.g., Tx leakage signal 520) that are coupled directly from Tx antenna 512 to Rx antenna 514 without reflecting from any objects. For example, leakage signals can include signals that are transferred from a transmitter antenna (e.g., Tx antenna 512) on a wireless device to a receive antenna (e.g., Rx antenna 514) on the wireless device without reflecting from any objects. In some cases, Rx waveform 518 can include multiple sequences that correspond to multiple copies of a sequence that are included in Tx waveform 516. In some examples, wireless device 500 can combine the multiple sequences that are received by RF receiver 510 to improve the signal to noise ratio (SNR).

Wireless device 500 can further implement RF sensing techniques by obtaining RF sensing data associated with each of the received signals corresponding to Tx waveform 516. In some examples, the RF sensing data can include channel state information (CSI) data relating to the direct paths (e.g., leakage signal 520) of Tx waveform 516 together with data relating to the reflected paths (e.g., Rx waveform 518) that correspond to Tx waveform 516.

In some aspects, RF sensing data (e.g., CSI data) can include information that can be used to determine the manner in which an RF signal (e.g., Tx waveform 516) propagates from RF transmitter 506 to RF receiver 510. RF sensing data can include data that corresponds to the effects on the transmitted RF signal due to scattering, fading, and/or power decay with distance, or any combination thereof. In some examples, RF sensing data can include imaginary data and real data (e.g., I/Q components) corresponding to each tone in the frequency domain over a particular bandwidth.

In some examples, RF sensing data can be used by the processor(s) 522 to calculate distances and angles of arrival that correspond to reflected waveforms, such as Rx waveform 518. In further examples, RF sensing data can also be used to detect motion, determine location, detect changes in location or motion patterns, or any combination thereof. In some cases, the distance and angle of arrival of the reflected signals can be used to identify the size, position, movement, and/or orientation of targets (e.g., target 502) in the surrounding environment in order to detect target presence/proximity.

The processor(s) 522 of the wireless device 500 can calculate distances and angles of arrival corresponding to reflected waveforms (e.g., the distance and angle of arrival corresponding to Rx waveform 518) by utilizing signal processing, machine learning algorithms, any other suitable technique, or any combination thereof. In other examples, wireless device 500 can transmit or send the RF sensing data to at least one processor of another computing device, such as a server or base station, that can perform the calculations to obtain the distance and angle of arrival corresponding to Rx waveform 518 or other reflected waveforms.

In one example, the distance of Rx waveform 518 can be calculated by measuring the difference in time from reception of the leakage signal to the reception of the reflected signals. For example, wireless device 500 can determine a baseline distance of zero that is based on the difference from the time the wireless device 500 transmits Tx waveform 516 to the time it receives leakage signal 520 (e.g., propagation delay). The processor(s) 522 of the wireless device 500 can then determine a distance associated with Rx waveform 518 based on the difference from the time the wireless device 500 transmits Tx waveform 516 to the time it receives Rx waveform 518 (e.g., time of flight, which is also referred to as round trip time (RTT)), which can then be adjusted according to the propagation delay associated with leakage signal 520. In doing so, the processor(s) 522 of the wireless device 500 can determine the distance traveled by Rx waveform 518 which can be used to determine the presence and movement of a target (e.g., target 502) that caused the reflection.

In further examples, the angle of arrival of Rx waveform 518 can be calculated by the processor(s) 522 by measuring the time difference of arrival of Rx waveform 518 between individual elements of a receive antenna array, such as antenna 514. In some examples, the time difference of arrival can be calculated by measuring the difference in received phase at each element in the receive antenna array.

In some cases, the distance and the angle of arrival of Rx waveform 518 can be used by processor(s) 522 to determine the distance between wireless device 500 and target 502 as well as the position of the target 502 relative to the wireless device 500. The distance and the angle of arrival of Rx waveform 518 can also be used to determine presence, movement, proximity, identity, or any combination thereof, of target 502. For example, the processor(s) 522 of the wireless device 500 can utilize the calculated distance and angle of arrival corresponding to Rx waveform 518 to determine that the target 502 is moving towards wireless device 500.

As noted above, wireless device 500 can include mobile devices (e.g., IoT devices, smartphones, laptops, tablets, etc.) or other types of devices. In some examples, wireless device 500 can be configured to obtain device location data and device orientation data together with the RF sensing data. In some instances, device location data and device orientation data can be used to determine or adjust the distance and angle of arrival of a reflected signal such as Rx waveform 518. For example, wireless device 500 may be set on the ground facing the sky as a target 502 (e.g., a vehicle) moves towards it during the RF sensing process. In this instance, wireless device 500 can use its location data and orientation data together with the RF sensing data to determine the direction that the target 502 is moving.

In some examples, device position data can be gathered by wireless device 500 using techniques that include RTT measurements, time of arrival (TOA) measurements, time difference of arrival (TDOA) measurements, passive positioning measurements, angle of arrival (AOA) measurements, angle of departure (AoD) measurements, received signal strength indicator (RSSI) measurements, CSI data, using any other suitable technique, or any combination thereof. In further examples, device orientation data can be obtained from electronic sensors on the wireless device 500, such as a gyroscope, an accelerometer, a compass, a magnetometer, a barometer, any other suitable sensor, or any combination thereof.

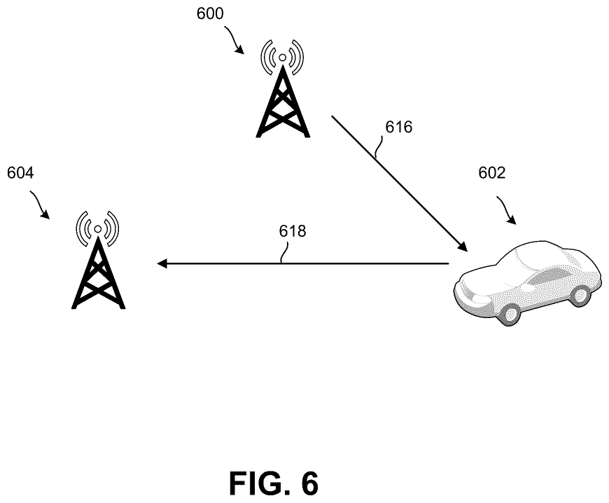

FIG. 6 is a diagram illustrating an example of a receiver 604 utilizing RF bistatic sensing techniques with one transmitter 600 for determining one or more characteristics (e.g., location, speed or velocity, heading, etc.) of a target 602 object. For example, the receiver 604 can use the RF bistatic sensing to detect a presence and location of a target 602 (e.g., an object, user, or vehicle), which is illustrated in the form of a vehicle in FIG. 6. In one example, the receiver 604 may be in the form of a base station, such as a gNB.

The bistatic radar system of FIG. 6 includes a transmitter 600 (e.g., a transmit sensing node), which in this figure is depicted to be in the form of a base station (e.g., gNB), and a receiver 604 (e.g., a receive sensing node) that are separated by a distance comparable to the expected target distance. As compared to the monostatic system of FIG. 5, the transmitter 600 and the receiver 604 of the bistatic radar system of FIG. 6 are located remote from one another. Conversely, monostatic radar is a radar system (e.g., the system of FIG. 5) comprising a transmitter (e.g., the RF transmitter 506 of wireless device 500 of FIG. 5) and a receiver (e.g., the RF receiver 510 of wireless device 500 of FIG. 5) that are co-located with one another.

An advantage of bistatic radar (or more generally, multistatic radar, which has more than one receiver) over monostatic radar is the ability to collect radar returns reflected from a scene at angles different than that of a transmitted pulse. This can be of interest to some applications (e.g., vehicle applications, scenes with multiple objects, military applications, etc.) where targets may reflect the transmitted energy in many directions (e.g., where targets are specifically designed to reflect in many directions), which can minimize the energy that is reflected back to the transmitter. It should be noted that, in one or more examples, a monostatic system can coexist with a multistatic radar system, such as when the transmitter also has a co-located receiver.

In some examples, the transmitter 600 and/or the receiver 604 of FIG. 6 can be a mobile phone, a tablet computer, a wearable device, a vehicle, or other device (e.g., device 407 of FIG. 4) that includes at least one RF interface. In some examples, the transmitter 600 and/or the receiver 604 can be a device that provides connectivity for a user device (e.g., for IoT device 407 of FIG. 4), such as a base station (e.g., a gNB, eNB, etc.), a wireless access point (AP), or other device that includes at least one RF interface.

In some aspects, transmitter 600 can include one or more components for transmitting an RF signal. The transmitter 600 can include at least one processor (e.g., the at least one processor 522 of FIG. 5) that is capable of determining signals (e.g., determining the waveforms for the signals) to be transmitted. The transmitter 600 can also include an RF transmitter (e.g., the RF transmitter 506 of FIG. 5) for transmission of a Tx signal comprising Tx waveform 616. The RF transmitter can be a transmitter configured to transmit cellular or telecommunication signals (e.g., a transmitter configured to transmit 5G/NR signals, 4G/LTE signals, or other cellular/telecommunication signals, etc.), a Wi-Fi transmitter, a Bluetooth™ transmitter, any combination thereof, or any other transmitter capable of transmitting an RF signal.

The RF transmitter can be coupled to one or more transmitting antennas, such as a Tx antenna (e.g., the TX antenna 512 of FIG. 5). In some examples, a Tx antenna can be an omnidirectional antenna that is capable of transmitting an RF signal in all directions, or a directional antenna that transmits an RF signal in a particular direction. In some examples, the Tx antenna may include multiple antennas (e.g., elements) configured as an antenna array.

The receiver 604 can include one or more components for receiving an RF signal. For example, the receiver 604 may include one or more receiving antennas, such as an Rx antenna (e.g., the Rx antenna 514 of FIG. 5). In some examples, an Rx antenna can be an omnidirectional antenna capable of receiving RF signals from multiple directions, or a directional antenna that is configured to receive signals from a particular direction. In further examples, the Rx antenna can include multiple antennas (e.g., elements) configured as an antenna array.

The receiver 604 may also include an RF receiver (e.g., RF receiver 510 of FIG. 5) coupled to the Rx antenna. The RF receiver may include one or more hardware components for receiving an RF waveform such as a Wi-Fi signal, a Bluetooth™ signal, a 5G/NR signal, or any other RF signal. The output of the RF receiver can be coupled to at least one processor (e.g., the at least one processor 522 of FIG. 5). The processor(s) may be configured to process a received waveform (e.g., Rx waveform 618).

In one or more examples, transmitter 600 can implement RF sensing techniques, for example bistatic sensing techniques, by causing a Tx waveform 616 to be transmitted from a Tx antenna. It should be noted that although the Tx waveform 616 is illustrated as a single line, in some cases, the Tx waveform 616 can be transmitted in all directions by an omnidirectional Tx antenna.

In one or more aspects, one or more parameters associated with the Tx waveform 616 may be used to increase or decrease RF sensing resolution. The parameters may include frequency, bandwidth, number of spatial streams, the number of antennas configured to transmit Tx waveform 616, the number of antennas configured to receive a reflected RF signal (e.g., Rx waveform 618) corresponding to the Tx waveform 616, the number of spatial links (e.g., number of spatial streams multiplied by number of antennas configured to receive an RF signal), the sampling rate, or any combination thereof. The transmitted waveform (e.g., Tx waveform 616) and the received waveform (e.g., the Rx waveform 618) can include one or more radar RF sensing signals (also referred to as RF sensing RSs).

During operation, the receiver 604 (e.g., which operates as a receive sensing node) can receive signals that correspond to Tx waveform 616, which is transmitted by the transmitter 600 (e.g., which operates as a transmit sensing node). For example, the receiver 604 can receive signals that are reflected from objects or people that are within range of the Tx waveform 616, such as Rx waveform 618 reflected from target 602. In some cases, the Rx waveform 618 can include multiple sequences that correspond to multiple copies of a sequence that are included in the Tx waveform 616. In some examples, the receiver 604 may combine the multiple sequences that are received to improve the SNR.

In some examples, RF sensing data can be used by at least one processor within the receiver 604 to calculate distances, angles of arrival, or other characteristics that correspond to reflected waveforms, such as the Rx waveform 618. In other examples, RF sensing data can also be used to detect motion, determine location, detect changes in location or motion patterns, or any combination thereof. In some cases, the distance and angle of arrival of the reflected signals can be used to identify the size, position, movement, and/or orientation of targets (e.g., target 602) in the surrounding environment in order to detect target presence/proximity.

The processor(s) of the receiver 604 can calculate distances and angles of arrival corresponding to reflected waveforms (e.g., the distance and angle of arrival corresponding to the Rx waveform 618) by using signal processing, machine learning algorithms, any other suitable technique, or any combination thereof. In other examples, the receiver 604 can transmit or send the RF sensing data to at least one processor of another computing device, such as a server, that can perform the calculations to obtain the distance and angle of arrival corresponding to the Rx waveform 618 or other reflected waveforms.

In one or more examples, the angle of arrival of the Rx waveform 618 can be calculated by a processor(s) of the receiver 604 by measuring the time difference of arrival of the Rx waveform 618 between individual elements of a receive antenna array of the receiver 604. In some examples, the time difference of arrival can be calculated by measuring the difference in received phase at each element in the receive antenna array.

In some cases, the distance and the angle of arrival of the Rx waveform 618 can be used by the processor(s) of the receiver 604 to determine the distance between the receiver 604 and the target 602 as well as the position of target 602 relative to the receiver 604. The distance and the angle of arrival of the Rx waveform 618 can also be used to determine presence, movement, proximity, identity, or any combination thereof, of the target 602. For example, the processor(s) of the receiver 604 may use the calculated distance and angle of arrival corresponding to the Rx waveform 618 to determine that the target 602 is moving towards the receiver 604.

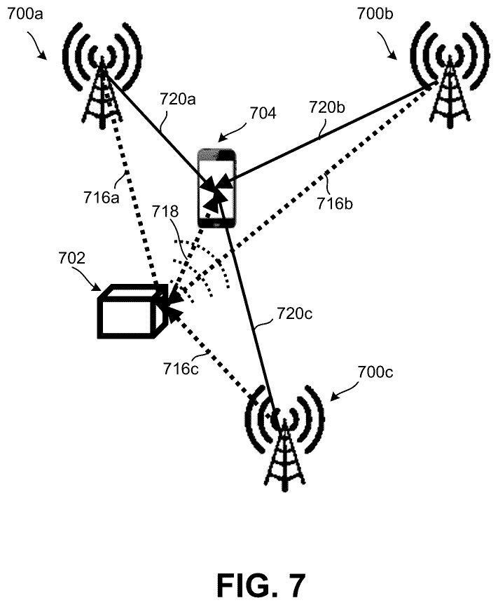

FIG. 7 is a diagram illustrating an example of a receiver 704, in the form of a smart phone, utilizing RF bistatic sensing techniques with multiple transmitters (including a transmitter 700a, a transmitter 700b, and a transmitter 700c), which may be employed to determine one or more characteristics (e.g., location, velocity or speed, heading, etc.) of a target 702 object. For example, the receiver 704 may use RF bistatic sensing to detect a presence and location of a target 702 (e.g., an object, user, or vehicle). The target 702 is depicted in FIG. 7 in the form of an object that does not have communications capabilities (which can be referred to as a device-free object), such as a person, a vehicle (e.g., a vehicle without the ability to transmit and receive messages, such as using C-V2X or DSRC protocols), or other device-free object. The bistatic radar system of FIG. 7 is similar to the bistatic radar system of FIG. 6, except that the bistatic radar system of FIG. 7 has multiple transmitters 700a, 700b, 700c, while the bistatic radar system of FIG. 6 has only one transmitter 600.

The bistatic radar system of FIG. 7 includes multiple transmitters 700a, 700b, 700c (e.g., transmit sensing nodes), which are illustrated to be in the form of base stations. The bistatic radar system of FIG. 7 also includes a receiver 704 (e.g., a receive sensing node), which is depicted in the form of a smart phone. The each of the transmitters 700a. 700b, 700c is separated from the receiver 704 by a distance comparable to the expected distance from the target 702. Similar to the bistatic system of FIG. 6, the transmitters 700a, 700b, 700c and the receiver 704 of the bistatic radar system of FIG. 7 are located remote from one another.

In one or more examples, the transmitters 700a, 700b, 700c and/or the receiver 704 may each be a mobile phone, a tablet computer, a wearable device, a vehicle (e.g., a vehicle configured to transmit and receive communications according to C-V2X, DSRC, or other communication protocol), or other device (e.g., device 407 of FIG. 4) that includes at least one RF interface. In some examples, the transmitters 700a, 700b, 700c and/or the receiver 704 may each be a device that provides connectivity for a user device (e.g., for IoT device 407 of FIG. 4), such as a base station (e.g., a gNB, cNB, etc.), a wireless access point (AP), or other device that includes at least one RF interface.

The transmitters 700a, 700b, 700c may include one or more components for transmitting an RF signal. Each of the transmitters 700a, 700b, 700c may include at least one processor (e.g., the processor(s) 522 of FIG. 5) that is capable of determining signals (e.g., determining the waveforms for the signals) to be transmitted. Each of the transmitters 700a, 700b, 700c can also include an RF transmitter (e.g., the RF transmitter 506 of FIG. 5) for transmission of Tx signals comprising Tx waveforms 716a, 716b, 716c, 720a, 720b, 720c. In one or more examples, Tx waveforms 716a, 716b, 716c are RF sensing signals, and Tx waveforms 720a, 720b, 720c are communications signals. In one or more examples, the Tx waveforms 720a, 720b, 720c are communications signals that may be used for scheduling transmitters (e.g., transmitters 700a, 700b, 700c) and receivers (e.g., receiver 704) for performing RF sensing of a target (e.g., target 702) to obtain location information regarding the target. The RF transmitter can be a transmitter configured to transmit cellular or telecommunication signals (e.g., a transmitter configured to transmit 5G/NR signals, 4G/LTE signals, or other cellular/telecommunication signals, etc.), a Wi-Fi transmitter, a Bluetooth™ transmitter, any combination thereof, or any other transmitter capable of transmitting an RF signal.

The RF transmitter may be coupled to one or more transmitting antennas, such as a Tx antenna (e.g., the TX antenna 512 of FIG. 5). In one or more examples, a Tx antenna can be an omnidirectional antenna that is capable of transmitting an RF signal in all directions, or a directional antenna that transmits an RF signal in a particular direction. The Tx antenna may include multiple antennas (e.g., elements) configured as an antenna array.

The receiver 704 of FIG. 7 may include one or more components for receiving an RF signal. For example, the receiver 704 can include one or more receiving antennas, such as an Rx antenna (e.g., the Rx antenna 514 of FIG. 5). In one or more examples, an Rx antenna can be an omnidirectional antenna capable of receiving RF signals from multiple directions, or a directional antenna that is configured to receive signals from a particular direction. In some examples, the Rx antenna may include multiple antennas (e.g., elements) configured as an antenna array (e.g., a phase antenna array).

The receiver 704 can also include an RF receiver (e.g., RF receiver 510 of FIG. 5) coupled to the Rx antenna. The RF receiver may include one or more hardware components for receiving an RF waveform such as a Wi-Fi signal, a Bluetooth™ signal, a 5G/NR signal, or any other RF signal. The output of the RF receiver can be coupled to at least one processor (e.g., the processor(s) 522 of FIG. 5). The processor(s) may be configured to process a received waveform (e.g., Rx waveform 718, which is a reflection (echo) RF sensing signal).

In some examples, the transmitters 700a, 700b, 700c can implement RF sensing techniques, for example bistatic sensing techniques, by causing Tx waveforms 716a, 716b, 716c (e.g., radar sensing signals) to be transmitted from a Tx antenna associated with each of the transmitters 700a, 700b, 700c. Although the Tx waveforms 716a, 716b, 716c are illustrated as single lines, in some cases, the Tx waveforms 716a, 716b, 716c may be transmitted in all directions (e.g., by an omnidirectional Tx antenna associated with each of the transmitters 700a, 700b, 700c).

In one or more aspects, one or more parameters associated with the Tx waveforms 716a, 716b, 716c may be used to increase or decrease RF sensing resolution. The parameters can include, but are not limited to, frequency, bandwidth, number of spatial streams, the number of antennas configured to transmit Tx waveforms 716a, 716b, 716c, the number of antennas configured to receive a reflected (echo) RF signal (e.g., Rx waveform 718) corresponding to each of the Tx waveforms 716a, 716b, 716c, the number of spatial links (e.g., number of spatial streams multiplied by number of antennas configured to receive an RF signal), the sampling rate, or any combination thereof. The transmitted waveforms (e.g., Tx waveforms 716a, 716b, 716c) and the received waveforms (e.g., the Rx waveform 718) may include one or more radar RF sensing signals (also referred to as RF sensing RSs). It should be noted that although only one reflected sensing signal (e.g., Rx waveform 718) is shown in FIG. 7, it is understood that a separate reflection (echo) sensing signal will be generated by each sensing signal (e.g., Tx waveforms 716a, 716b, 716c) reflecting off of the target 702.

During operation of the system of FIG. 7, the receiver 704 (e.g., which operates as a receive sensing node) can receive signals that correspond to Tx waveforms 716a. 716b, 716c, which are transmitted by the transmitters 700a, 700b, 700c (e.g., which each operate as a transmit sensing node). The receiver 704 can receive signals that are reflected from objects or people that are within range of the Tx waveforms 716a, 716b, 716c, such as Rx waveform 718 reflected from the target 702. In one or more examples, the Rx waveform 718 may include multiple sequences that correspond to multiple copies of a sequence that are included in its corresponding Tx waveform 716a, 716b, 716c. In some examples, the receiver 704 may combine the multiple sequences that are received to improve the SNR.

In some examples, RF sensing data can be used by at least one processor within the receiver 704 to calculate distances, angles of arrival (AOA), TDOA, angle of departure (AoD), or other characteristics that correspond to reflected waveforms (e.g., Rx waveform 718). In further examples, RF sensing data can also be used to detect motion, determine location, detect changes in location or motion patterns, or any combination thereof. In one or more examples, the distance and angle of arrival of the reflected signals can be used to identify the size, position, movement, and/or orientation of targets (e.g., target 702) in order to detect target presence/proximity.

The processor(s) of the receiver 704 can calculate distances and angles of arrival corresponding to reflected waveforms (e.g., the distance and angle of arrival corresponding to the Rx waveform 718) by using signal processing, machine learning algorithms, any other suitable technique, or any combination thereof. In one or more examples, the receiver 704 can transmit or send the RF sensing data to at least one processor of another computing device, such as a server, that can perform the calculations to obtain the distance and angle of arrival corresponding to the Rx waveform 718 or other reflected waveforms (not shown).

In one or more examples, a processor(s) of the receiver 704 can calculate the angle of arrival (AOA) of the Rx waveform 718 by measuring the TDOA of the Rx waveform 718 between individual elements of a receive antenna array of the receiver 704. In some examples, the TDOA can be calculated by measuring the difference in received phase at each element in the receive antenna array. In one illustrative example, to determine TDOA, the processor(s) can determine the difference time of arrival of the Rx waveform 718 to the receive antenna array elements, using one of them as a reference. The time difference is proportional to distance differences.

In some cases, the processor(s) of the receiver 704 can use the distance, the AOA, the TDOA, other measured information (e.g., AoD, etc.), any combination thereof, of the Rx waveform 718 to determine the distance between the receiver 704 and the target 702, and determine the position of target 702 relative to the receiver 704. In one example, the processor(s) can apply a multilateration or other location-based algorithm using the distance, AOA, and/or TDOA information as input to determine a position (e.g., 3D position) of the target 702. In other examples, the processor(s) can use the distance, the AOA, and/or the TDOA of the Rx waveform 718 to determine a presence, movement (e.g., velocity or speed, heading or direction or movement, etc.), proximity, identity, any combination thereof, or other characteristic of the target 702. For instance, the processor(s) of the receiver 704 may use the distance, the AOA, and/or the TDOA corresponding to the Rx waveform 718 to determine that the target is moving towards the receiver 704.

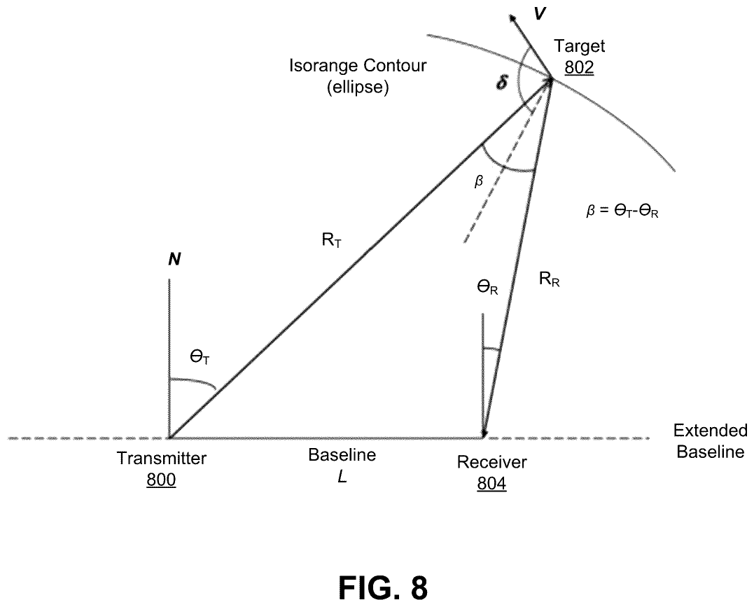

FIG. 8 is a diagram illustrating geometry for bistatic (or monostatic) sensing. FIG. 8 shows a bistatic radar North-reference coordinate system in two-dimensions. In particular, FIG. 8 shows a coordinate system and parameters defining bistatic radar operation in a plane (referred to as a bistatic plane) containing a transmitter 800, a receiver 804, and a target 802. A bistatic triangle lies in the bistatic plane. The transmitter 800, the target 802, and the receiver 804 are shown in relation to one another. The transmitter 800 and the receiver 804 are separated by a baseline distance L. The extended baseline is defined as continuing the baseline distance L beyond either the transmitter 800 or the receiver 804. The target 802 and the transmitter 800 are separated by a distance RT, and the target 802 and the receiver 804 are separated by a distance RR.

Angles θ_{T} and θ_{R} are, respectively, the transmitter 800 and receiver 804 look angles, which are taken as positive when measured clockwise from North (N). The angles θ_{T} and θ_{R} are also referred to as angles of arrival (AOA) or lines of sight (LOS). A bistatic angle (β) is the angle subtended between the transmitter 800, the target 802, and the receiver 804 in the radar. In particular, the bistatic angle is the angle between the transmitter 800 and the receiver 804 with the vertex located at the target 802. The bistatic angle is equal to the transmitter 800 look angle minus the receiver 804 look angle θ_{R} (e.g., β=θ_{T}−θ_{R}).

When the bistatic angle is exactly zero (0), the radar is considered to be a monostatic radar; when the bistatic angle is close to zero, the radar is considered to be pseudo-monostatic; and when the bistatic angle is close to 180 degrees, the radar is considered to be a forward scatter radar. Otherwise, the radar is simply considered to be, and referred to as, a bistatic radar. The bistatic angle (β) can be used in determining the radar cross section of the target.

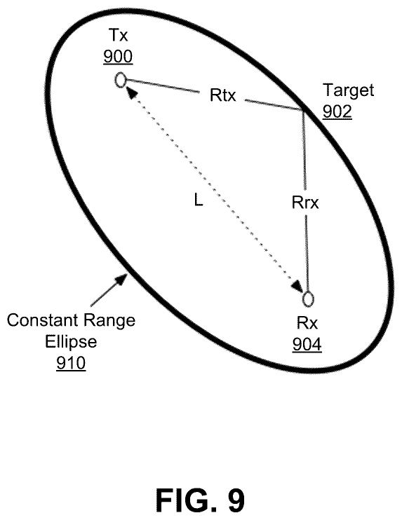

FIG. 9 is a diagram illustrating an example of a bistatic range 910 of bistatic sensing. In this figure, a transmitter (Tx) 900, a target 902, and a receiver (Rx) 904 of a radar are shown in relation to one another. The transmitter 900 and the receiver 904 are separated by a baseline distance L, the target 902 and the transmitter 900 are separated by a distance Rtx, and the target 902 and the receiver 904 are separated by a distance Rrx.

Bistatic range 910 (shown as an ellipse) refers to the measurement range made by radar with a separate transmitter 900 and receiver 904 (e.g., the transmitter 900 and the receiver 904 are located remote from one another). The receiver 904 measures the time of arrival from when the signal is transmitted by the transmitter 900 to when the signal is received by the receiver 904 from the transmitter 900 via the target 902. The bistatic range 910 defines an ellipse of constant bistatic range, referred to an iso-range contour, on which the target 902 lies, with foci centered on the transmitter 900 and the receiver 904. If the target 902 is at range Rrx from the receiver 904 and range Rtx from the transmitter 900, and the receiver 904 and the transmitter 900 are located a distance L apart from one another, then the bistatic range is equal to Rrx+Rtx−L. It should be noted that motion of the target 902 causes a rate of change of bistatic range, which results in bistatic Doppler shift.

Generally, constant bistatic range points draw an ellipsoid, with the transmitter 900 and the receiver 904 positions as the focal points. The bistatic iso-range contours are where the ground slices the ellipsoid. When the ground is flat, this intercept forms an ellipse (e.g., bistatic range 910). Note that except when the two platforms have equal altitude, these ellipses are not centered on a specular point.

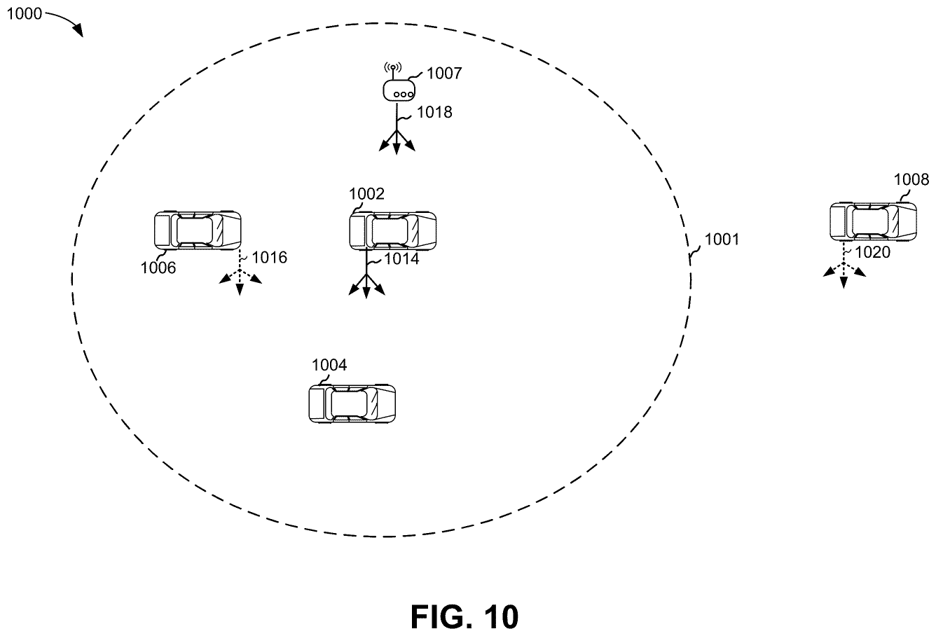

FIG. 10 illustrates an example 1000 of wireless communication between devices based on sidelink communications. The communication may be based on a slot structure (e.g., the slot structure as shown in FIG. 3). For example, transmitting UE 1002 may transmit a transmission 1014, e.g., comprising a control channel and/or a corresponding data channel, that may be received by receiving UEs 1004, 1006, 1008. At least one UE may be in the form of an autonomous vehicle or an unmanned aerial vehicle. A control channel may include information for decoding a data channel and may also be used by receiving device to avoid interference by refraining from transmitting on the occupied resources during a data transmission. The number of transmission time intervals (TTIs), as well as the RBs, that will be occupied by the data transmission, may be indicated in a control message from the transmitting device. The UEs 1002, 1004, 1006, 1008 may each be capable of operating as a transmitting device in addition to operating as a receiving device. Thus, UEs 1006, 1008 are illustrated as transmitting transmissions 1016, 1020. The transmissions 1014, 1016, 1020 (and 1018 by a network device 1007, such as a roadside unit) may be broadcast or multicast to nearby devices. For example, UE 1014 may transmit communication intended for receipt by other UEs within a range 1001 of UE 1014. Additionally/alternatively, network device 1007 may receive communication from and/or transmit communication 1018 to UEs 1002, 1004, 1006, 1008. UEs 1002, 1004, 1006, 1008 or network device 1007 may include a detection component. UEs 1002, 1004, 1006, 1008 or network device 1007 may also include a vehicle-based safety message or mitigation component.

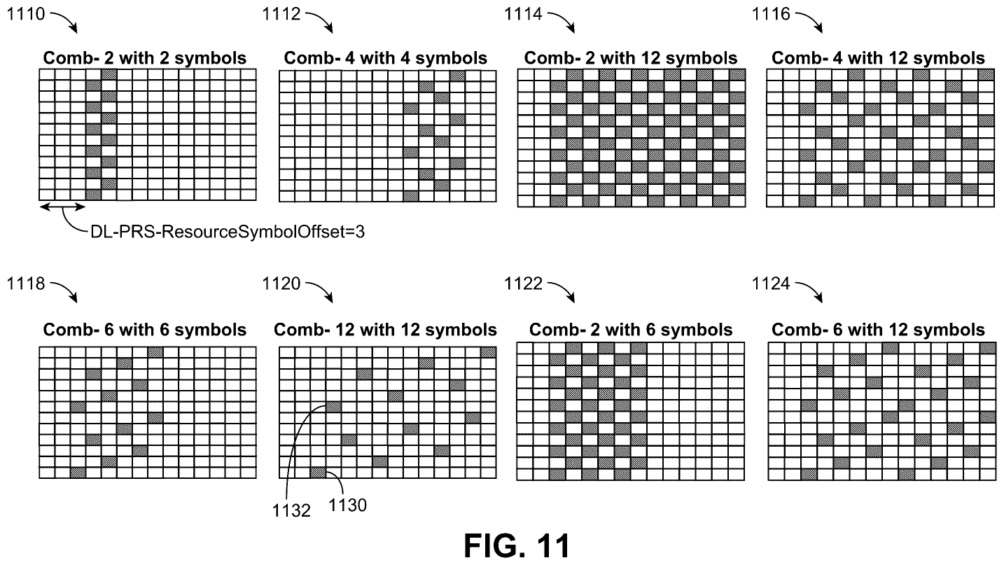

Examples of comb structures for reference signals (e.g., a PRS, SRS, etc.) are shown in FIG. 11. For example, the comb structure 1110 is a comb-2 structure with two symbols (denoted as a comb-2/2-symbol structure). According to the comb-2/2-symbol structure of the comb structure 1110, every alternate symbol is assigned to the reference signal resources. The comb patterns in FIG. 11 are for one Transmission-Reception Point (TRP). A summary of the comb structures 1110, 1112, 1114, 1116, 1118, 1120, 1122, and 1124 are provided in Table 2 below:

TABLE 2

| | 2-Symbols | 4-Symbols | 6-Symbols | 12-Symbols |
|---|---|---|---|---|
| Comb-2 | {0, 1} | {0, 1, 0, 1} | {0, 1, 0, 1, 0, 1} | {0, 1, 0, 1, 0, 1, 0, 1, 0, 1, 0, 1} |
| Comb-4 | N/A | {0, 2, 1, 3} | N/A | {0, 2, 1, 3, 0, 2, 1, 3, 0, 2, 1, 3} |
| Comb-6 | N/A | N/A | {0, 3, 1, 4, 2, 5} | {0, 3, 1, 4, 2, 5, 0, 1, 3, 4, 2, 5} |
| Comb-12 | N/A | N/A | N/A | {0, 6, 3, 9, 1, 7, 4, 10, 2, 8, 5, 11} |

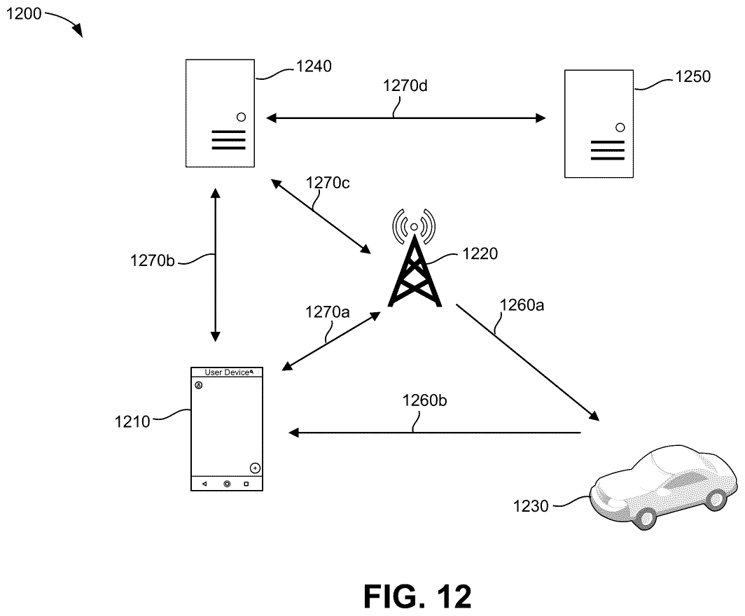

As previously noted, systems and techniques are described herein that apply solutions associated with joint RF sensing and energy harvesting for UAV use cases. FIG. 12 is a diagram illustrating an example of a system 1200 for applying solutions (e.g., methods or rules) for joint RF sensing and energy harvesting for UAV use cases. In FIG. 12, the system 1200 is shown to include a network device 1210 in the form of a UE. The network device 1210 (e.g., UE) can operate as a radar Rx for sensing purposes. Also shown is a network entity 1220 in the form of a base station (e.g., gNB or a portion of a gNB, such as a CU, DU, RU, Near-RT RIC, Non-RT RIC, etc.). The network entity 1220 (e.g., gNB) can operate as a radar Tx for sensing purposes. The system 1200 also includes a plurality of network entities 1240, 1250, where network entity 1240 is in the form of a radar server and network entity 1250 is in the form of a location server.

The system 1200 may include more or less network devices and/or more or less network entities, than as shown in FIG. 12. In addition, the system 1200 may include different types of network devices (e.g., vehicles) and/or different types of network entities (e.g., network servers) than as shown in FIG. 12. Also, a UE may be employed as the radar Tx instead of a base station (e.g., gNB) as is shown in FIG. 12. In addition, in one or more examples, the network device 1210 (e.g., UE) may be equipped with heterogeneous capability, which may include, but is not limited to, 4G/5G cellular connectivity, GPS capability, camera capability, radar capability, and/or LIDAR capability. The network device 1210 and network entities 1220, 1240, 1250 may be capable of performing wireless communications with each other via communications signals (e.g., signals 1270a, 1270b, 1270c, 1270d).

In one or more examples, the network device 1210 and network entity 1220 may be capable of transmitting and receiving sensing signals of some kind (e.g., camera, RF sensing signals, optical sensing signals, etc.). In some cases, the network device 1210 and the network entity 1220 may transmit and receive sensing signals (e.g., RF sensing signals 1260a, 1260b) for using one or more sensors to detect nearby targets (e.g., target 1230, which is in the form of a vehicle). In some cases, the network device 1210 and the network entity 1220 can detect nearby targets based on one or more images or frames captured using one or more cameras.

The network entity 1220, which may operate as a radar Tx, may perform RF sensing (e.g., bistatic sensing or monostatic sensing) of at least one target (e.g., target 1230) to obtain RF sensing measurements (e.g., Doppler, RTT, TOA, and/or TDOA measurements) of the target(s) (e.g., target 1230). The RF sensing measurements of the target(s) (e.g., target 1230) can be used (e.g., by at least one processor(s) of at least one of the network device 1210 and the network entity 1220 and/or at least one of the network entities 1240, 1250) to determine one or more characteristics (e.g., speed, location, distance, movement, heading, size, and/or other characteristics) of the target(s) (e.g., target 1230).

As previously mentioned, generally, sensing involves monitoring moving targets (e.g., target 1230) with different motions (e.g., a moving car or pedestrian, a body motion of a person, such as breathing, and/or other micro-motions related to a target). Doppler, which measures the phase variation in a signal and is indicative of motion, is an important characteristic for sensing of a target (e.g., target 1230). As such, in order to obtain an accurate estimation of the motion of the target, the phase of the signal should be continuous (e.g., the signal should maintain phase continuity).

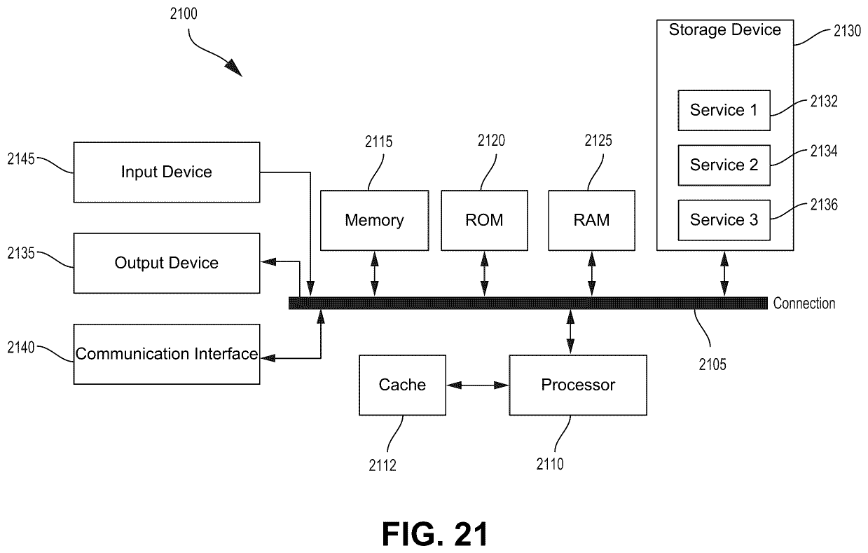

During operation of the system 1200, for example when performing bistatic sensing of a target (e.g., target 1230), a network entity 1220 (e.g., base station), operating as a radar Tx, may transmit an RF sensing signal 1260a towards the target (e.g., target 1230). The RF sensing signal 1260a may be included within communication signals and sensing signals multiplexed (e.g., via time division multiplexing and/or frequency division multiplexing) together for joint communications and sensing purposes. The sensing signal 1260a can reflect off of the target (e.g., target 1230) to produce an RF reflection sensing signal 1260b, which may be reflected towards network device 1210 (e.g., UE). The network device 1210 (e.g., UE), operating as a radar Rx, can receive the reflection sensing signal 1260b. After the network device (e.g., UE) receives the reflection sensing signal 1260b, the network device (e.g., UE) can obtain measurements (e.g., Doppler, RTT, TOA, and/or TDOA measurements) of the reflection sensing signal 1260b. At least one processor (e.g., processor 2110 of FIG. 21) of at least one of the network device 1210 and the network entity 1220 and/or at least one of the network entities 1240, 1250 may then determine or compute the characteristics (e.g., speed, location, distance, movement, heading, size, etc.) of the target (e.g., target 1230) by using sensing measurements (e.g., Doppler, RTT, TOA, and/or TDOA measurements) from the received reflection sensing signal 1260b.

In some examples, the network device 1210 (e.g., UE) may transmit the measurements (e.g., Doppler, RTT, TOA, and/or TDOA measurements) and/or determined characteristics (e.g., speed, location, distance, movement, heading, size, etc.) of the target (e.g., target 1230) to the network entity 1220 (e.g., base station, such as a gNB) and/or network entity 1240 (e.g., radar server) via communication signals 1270a, 1270b. The network entity 1220 (e.g., base station) and/or network entity 1240 (e.g., radar server) may then transmit the measurements (e.g., Doppler, RTT, TOA, and/or TDOA measurements) and/or determined characteristics (e.g., speed, location, distance, movement, heading, size, etc.) of the target (e.g., target 1230) to the network entity 1240 (e.g., radar server) and/or network entity 1250 (e.g., location server such as a location management function (LMF)) via communication signals 1270c, 1270d.

As previously mentioned, currently. UA Vs are utilized for many use cases. Rel-17 of 3GPP includes a SA2 study item and a SA2 work item for UAVs, but does not include any RAN components for UAVs. The scope of work regarding UAVs (e.g., across both SA2 and RAN2) involves UAV authentication and authorization, identification (e.g., to support aviation regulations for broadcast remote identification), and UAV location and tracking.

UAV location and tracking can support multiple different models. For example, one model involves UAV reporting, which may be based on a request from a USS. For this model, the 3GPP system can provide the UAV location. Another model involves periodic UAV location reporting, which may be based on a request from the USS. For this model, the 3GPP system may periodically provide the UAV location, which can be based on an interval that may be negotiated between the USS and the 3GPP system. For another model, the UAV presence within a monitoring area (e.g., the UAV moving inside or outside of the monitoring area) can be monitored. A monitoring report may be provided to the USS. In one or more examples, in order to receive the reporting of the UE presence within the monitoring area, the USS may subscribe for event monitoring for a specific UAV by providing an “area of interest.” The 3GPP system can map the “area of interest” to 3GPP specific areas (e.g., such as cells), or can use the actual location based on 3GPP GMLC reporting. Another example model involves UAV discovery, where the USS can provide an “area of interest” and can receive from the 3GPP system, a listing of UAVs that are served by the 3GPP system and present within that specific area.

For some use cases. UAVs can be used as delivery platforms for delivery of packages. In one or more examples, the UAVs can be implemented as UEs (e.g., drones). In some cases, the UAVs can be in communication with base stations, such as gNBs. UAV performance as a delivery platform can often involve the weighting of tradeoffs between the distance traveled by the UAV and the package weight carried by the UAV. The delivery distance can be limited due to the battery size of the UAV and the weight of the package carried by the UAV. For a given delivery distance guarantee, for example, there can be a maximum weight of the package allowed for delivery by the UAV. For another example, for a given weight of the package to be delivered, there may be a maximum delivery distance allowed for delivery by the UAV. In one or more examples, there may be some use cases where there may need to be an extension of the range of the UAV delivery distance such that the UAV does not need to stop, during its delivery, to charge its battery.

In some use cases, a network entity (e.g., network entity 1220 of FIG. 12, such as a gNB or other network entity) can sense one or more UAVs (e.g., based on performing cellular-based wide area RF sensing). During the monitoring (e.g., sensing) of a UAV, the UAV may move (e.g., fly) through many cells, from one cell to another cell, to travel for a long distance. For wide-area RF sensing, the network entity (e.g., a base station, such as a gNB) may transmit with a high power (e.g., a power higher than the power used for communications) to meet the link budget requirements for the sensing. The transmission power for RF sensing by the network entity (e.g., a gNB) may be increased by employing a narrower beamwidth for the transmission beam for the sensing. These high-power sensing beams can present an opportunity for a UAV to harvest energy from the base station transmitted sensing signals to improve the distance and/or weight capability of the UAV.

In one or more aspects, the systems and techniques provide joint RF sensing and energy harvesting (EH) for one or more use cases. A use case of a UAV will be described herein for illustrative purposes. However, the systems and techniques can be applied to any type of device.

As described herein, the systems and techniques reuse RF sensing waveforms (e.g., transmitted by base stations) for energy harvesting purposes (e.g., for energy harvesting by UAVs). The RF sensing waveforms can be utilized for both sensing purposes and energy harvesting purposes. By allowing for UA Vs to harvest energy from base station transmitted sensing signals, the UAVs' delivery service can be enhanced by providing for longer delivery distances and/or for delivering of heavier packages.

There can be several advantages for UAVs employing EH sensing techniques (e.g., energy harvesting from RF sensing signals) over typical EH communication techniques (e.g., energy harvesting from RF communication signals). For example, for EH sensing techniques, a high-power sensing signal may be employed. In one or more examples, a UAV trajectory may be easier to predict (e.g., by the network, such as a network service) when there low multipath and a strong Doppler signature (e.g., from the high-power sensing signal). The prediction of the UAV trajectory can allow for a more efficient energy harvesting operation and RF sensing operation. For another example, if base stations (e.g., gNBs) exchange UAV trajectory information with each other (e.g., for seamless switching from one gNB to another, such as when the UAV exists in the coverage of a first gNB and enters a coverage area of a second gNB), the information can also include the altitude, which may be unique to the UAV. Another example is that a base station's (e.g., gNB's) transmission power for RF sensing can be higher than the transmission power for regular communication transmissions. This higher transmission power for RF sensing can be beneficial for the EH sensing techniques. For tracking a target (e.g., a UAV) after the detection of the target, the sensing beam beamwidth may be narrower (e.g., narrower than the beamwidth of the initial sensing beam used to detect the target) to provide for additional power gain for the EH of the UAV.

In one or more aspects, there may be several EH sensing scenarios. For example, for one scenario, joint RF sensing and EH may be employed for a purely passive UAV (e.g., a UAV that relies on an OTA based method for the joint RF sensing and EH). Since the UAV is purely passive, the UAV may not be in communication with the base station (e.g., gNB). For another scenario, joint RF sensing and EH may be employed for a UAV equipped with a UE. For this scenario, the overall efficiency of the joint RF sensing and EH operation may be enhanced by information sharing between the UAV and the network (e.g., a network server).

In one or more aspects, joint RF sensing and energy harvesting may be employed for a UAV without connection (e.g., the UAV does not have a communication capability with the operator owned base station, such as a gNB). The UAV does not have any connection with the base station (e.g., gNB) and, as such, there is no signaling between the UAV and the base station.

In one or more examples, for joint RF sensing and EH employed for a UAV without connection, the carrier frequency (e.g., and frequency bands) of the RF sensing service provided by the operator may be known and/or may be public. As such, the UAV vendor (or manufacturer) may design the UAV to have specific hardware (e.g., hardware which conducts some impedance matching to match with the frequency) to enable efficient energy harvesting using the base station (e.g., with RF sensing capabilities) as the RF source. The base station (e.g., gNB) may be functioning as the RF source for the energy harvesting.

In some examples, for joint RF sensing and EH employed for a UAV without connection, the UAV may be able to sense the carrier frequency (or frequency bands) of the RF sensing waveform (WF) and estimate the value of the carrier frequency (or frequency bands). The UAV may then be able to tune its hardware (e.g., for impedance matching) to the frequency to enable efficient energy harvesting using the base station (e.g., with RF sensing capabilities) as the RF source.

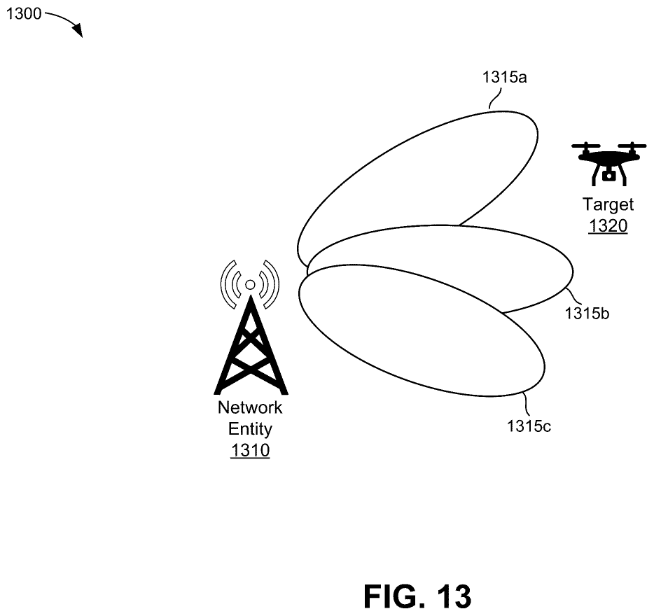

In one or more examples, the systems and techniques provide a method for joint RF sensing and EH employed for a UAV without connection. FIGS. 13, 14, and 15 together illustrate the method for joint RF sensing and EH employed for a UAV without connection. In particular, FIG. 13 is a diagram illustrating an example of a system 1300 for joint RF sensing and energy harvesting for UAV use cases, where the system 1300 is detecting a target 1320. In FIG. 13, the target 1320 (e.g., a network device, such as a UE in the form of a drone) and a network entity 1310 (e.g., a base station, such as a gNB) are shown. The network entity 1310 is shown to be transmitting (e.g., radiating) RF sensing signal beams 1315a. 1315b, 1315b (e.g., each with a wide beamwidth) in different directions towards the target 1320 (e.g., drone).

During operation of the method for joint RF sensing and EH employed for a UAV without connection, for a first step, at least one network entity (e.g., network entity 1310, such as a base station) can send (e.g., transmit) multiple beams 1315a, 1315b, 1315b (e.g., initially the beams should be wide beams) to detect the target 1320. Once the target is detected, for a second step, the network entity 1310 can track the target 1320 by transmitting (e.g., radiating) a RF sensing signal beam 1415 (e.g., with a narrow beamwidth) in a focused direction towards the target 1320.

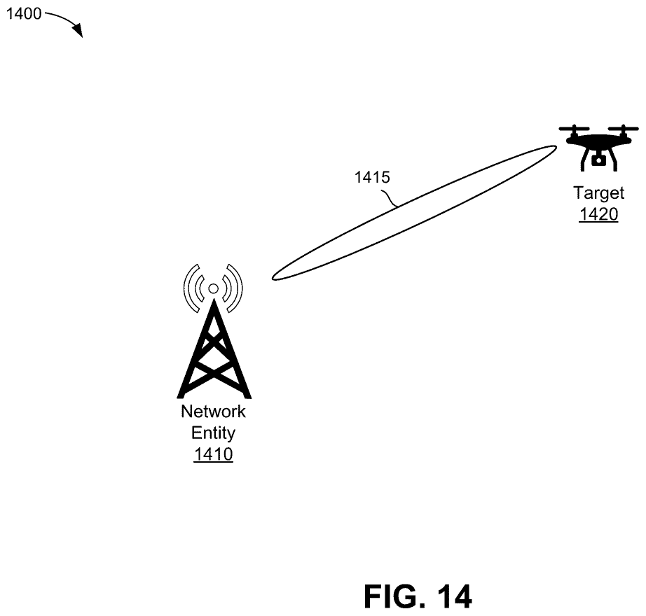

FIG. 14 is a diagram illustrating an example of a system 1400 for joint RF sensing and energy harvesting for UAV use cases, where the system 1400 is tracking the target 1420 using (e.g., transmitting) a narrow RF sensing signal beam 1415 and performing energy harvesting. If the network entity 1410 identifies that the target 1420 is a UAV, the network entity 1410 may increase its transmission power (e.g., of the narrow RF sensing signal beam 1415) for the RF sensing, even if the network entity 1410 has already been able to track the target 1420 with high signal quality, without the need for the network entity 1410 to increase the signal power. It is not necessary for the network entity 1410 to further increase its transmission power (e.g., of the narrow RF sensing signal beam 1415). However, as long as the network entity 1410 detects the target 1420 (e.g., UAV), the network entity 1410 may increase its transmission power (e.g., of the narrow RF sensing signal beam 1415) such that the network entity 1410 can charge (e.g., transfer) more power to the target 1410 (e.g., UAV) for energy harvesting by the target 1410 (e.g. UAV).

In one or more examples, there may be some prior negotiation between a vendor of the target 1420 (e.g., UAV) and an operator of the network entity 1410 (e.g., a base station, such as a gNB). The operator of the network entity 1410 may have some cooperation with the vendor of the target 1420 (e.g., UAV) such that the operator of the network entity 1410 will agree to support the target 1420 (e.g., a UAV) of the vendor (e.g., support by transferring power to the target by increasing the transmission power of the RF sensing beam), when the network entity 1410 of the operator has detected the target 1420 (e.g., UAV) of the vendor.

Also, during operation of the method for joint RF sensing and EH employed for a UAV without connection, when the network entity 1410 is no longer able to detect the target 1420 even with the high power narrow RF sensing signal beam 1415 (e.g., the target 1420 has flown outside of the coverage area of the network entity 1410), for a third step, the network entity 1410 can then proceed to perform the first step of the method again to attempt to detect another potential target within the coverage area of the network entity 1410.

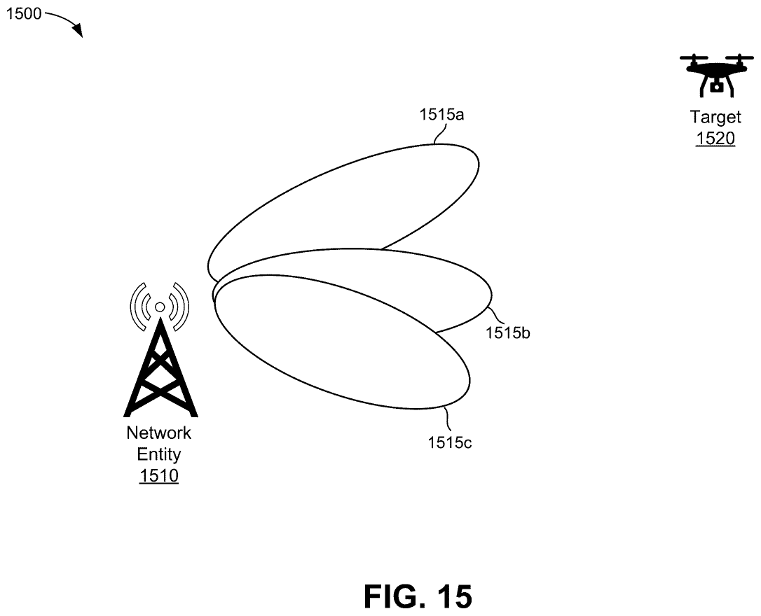

FIG. 15 is a diagram illustrating an example of a system 1500 for joint RF sensing and energy harvesting for UAV use cases, where the target 1520 is shown to be located outside of the sensing coverage area of the network entity 1510. In FIG. 15, the network entity 1510 is shown to be transmitting (e.g., radiating) RF sensing signal beams 1515a, 1515b, 1515b (e.g., each with a wide beamwidth) in different directions in an attempt to detect a target (e.g., not shown) that is located within the sensing coverage area of the network entity 1510. In one or more examples, the network entity 1510 (e.g., a base station, such as a gNB) may control its behavior based on the OTA RF sensing measurements it obtains during the sensing.

In one or more aspects, the network (e.g., network server) may further enhance the efficiency of the joint RF sensing and EH for a UAV without connection (e.g., the UAV does not have a communication capability with the operator owned base station, such as a gNB). In one or more examples, once the base station (e.g., gNB) has identified the target a being a UAV, the base station (e.g., gNB) can indicate to the network (e.g., to a sensing server in the network that is connected to all of the gNBs in the RAN) that the target is a UAV. If the network (e.g., network server) knows that a UAV is observed within the network (e.g., RAN), then the network (e.g., network server) may conduct some coordination across the base stations (e.g., gNBs) to increase the efficiency of the joint RF sensing and EH operation.

In one or more examples, the base station may report (e.g., send a report to the network, such as network server, with) the UAV's location information, which may include the range, speed, and/or angle of the UAV. In some examples, the base station (e.g., gNB) may report (e.g., send a report to the network, such as a network server, with) a sequence of the UAV's location information, which could be used for a prediction of the trajectory for the UAV. The sequence of the UAV's location information can be useful to the network (e.g., network server) because the network can use the sequence of the UAV's location information to determine a prediction of the UAV's trajectory (e.g., for a following time instance). In some examples, the angle information can indicate the altitude information, which can be unique to the UAV. In one or more examples, the base station (e.g., gNB) could report (e.g., send a report to the network, such as network server, with) the UAV's location information (e.g., speed and/or coordinates), where the coordinates (e.g., X, Y, Z coordinates) can also include the altitude information, which can be unique to the UAV. The network (e.g., network server) can predict a future location of the UAV, based on the speed and/or coordinates of the UAV. In some examples, the base station (e.g., gNB) can report (e.g., send a report to the network, such as network server, with) target identification (ID) for each UAV, as there may be multiple UAVs identified by the base station (e.g., gNB). The target ID information can be useful for the network (e.g., network server) to know specifically which UAV(s) have been detected by the base station (e.g., gNB).

In one or more examples, the network (e.g., a sensing server) could on-demand request base stations (e.g., gNBs) located within neighboring cells to join in the effort of UAV tracking and energy harvesting. For example, when the network (e.g., sensing server) knows the location information of a UAV, the network (e.g., sensing server) can notify other base stations (e.g., gNBs) located within neighboring cells to perform narrow beam beamforming in a direction towards the location of the UAV. As such, when the UAV leaves a sensing coverage area of one base station (e.g., gNB 1), another base station (e.g., gNB 2) can continuously track the UAV, when the UAV flies within the sensing coverage area of that base station (e.g., gNB 2).

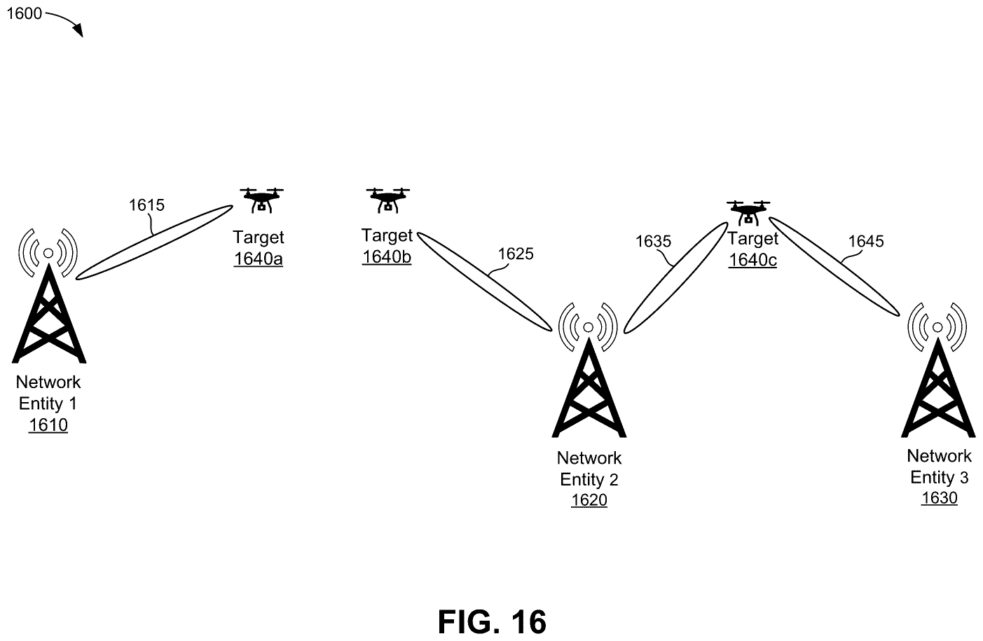

FIG. 16 shows an example where the network (e.g., sensing server, such as network entity 1240 of FIG. 12 in the form of a radar server) could on-demand request network entities 1620, 1630 (e.g., base stations, such as gNBs) located within neighboring cells to join in the effort of UAV tracking and energy harvesting. In particular, FIG. 16 is a diagram illustrating an example of a system 1600 for joint RF sensing and energy harvesting for UAV use cases, where the system 1600 includes multiple sensing network entities 1610, 1620, 1630 (e.g., base stations, such as gNBs) sensing a target. Each network entity 1610, 1620, 1630 is located in different cells, where each network entity 1610, 1620, 1630 is located within a respective cell. For example, network entity 1610 is located within cell 1, network entity 1620 is located within cell 2, and network entity 1630 is located within cell 3.

Also in FIG. 16, a UAV 1640a, 1640b, 1640c (e.g., a network device, such as a UE in the form of a drone) is shown. The UAV 1640a, 1640b, 1640c is shown to be located in three different positions, where each position is located within one or two cells. For example, for UAV 1640a, the UAV is located within a first position in the sky; for UAV 1640b, the UAV is located within a second position in the sky; and for UAV 1640c, the UAV is located within a third position in the sky.

During operation of the system 1600, after the network entity 1610 has detected a target, the network entity 1610 may transmit a high power narrow beam 1615 towards the target (e.g., UAV 1640a, which is located within the first position in the sky in cell 1). After the network entity 1610 has determined that the detected target is a UAV 1640a, the network entity 1610 can report to the network (e.g., a network server, such as a sensing server) the location information of the UAV 1640a. The network (e.g., sensing server) can then on-demand request the network entity 1620 (e.g., gNBs) located within a neighboring cell (e.g., cell 2) to join in the effort of tracking and energy harvesting for the UAV 1640a.

After the network entity 1620 receives the location information of the UAV 1640a, the network entity 1620 can transmit a high power narrow beam 1625 towards the UAV 1640a (e.g., which is located within the first position in the sky in cell 1). Once the UAV 1640a has flown outside of cell 1 and into cell 2, the UAV 1640b can be within the sensing coverage area of the network entity 1620. As the UAV 1640b flies across the sky in cell 2, the network entity 1620 can scan its high power narrow beam 1635 across the sky to continuously follow the UAV 1640c to position 3.

The network entity 1620 can report to the network (e.g., a network server, such as a sensing server) updated location information of the UAV 1640c. The network (e.g., sensing server) can then on-demand request the network entity 1630 (e.g., gNBs) located within a neighboring cell (e.g., cells 3) to join in the effort of tracking and energy harvesting for the UAV 1640c. After the network entity 1630 receives the updated location information of the UAV 1640c, the network entity 1630 can transmit a high power narrow beam towards the UAV 1640c (e.g., which is located within the third position in the sky in cell 3).

In one or more examples, the network (e.g., sensing server) could on-demand request the network entity (e.g., gNB) on the power control to support UAV EH. For example, the transmission power could be requested to be higher than the minimum required power for RF sensing. Typically, if there is no request, the network entity (e.g., gNB) may, on default, use regular RF sensing power. However, when the network (e.g., sensing server) knows that a UAV is being tracked by the network entity (e.g., gNB), the network (e.g., sensing server) may demand that the network entity (e.g., gNB), on some time instance, increase its sensing RF power. In some examples, the network (e.g., sensing server) may indicate a minimum duration of time for the higher-power transmission. As such, the network (e.g., sensing server) may indicate to the network entity (e.g., gNB) a time window for the network entity (e.g., gNB) to increase its RF sensing power.

In one or more aspects, joint RF sensing and energy harvesting may be employed for a UAV with connection, where the UAV can communicate with the operator owned network entity (e.g., gNB). The efficiency of the joint of sensing and the energy harvesting can be enhanced for these cases. In one or more examples, the UAV could report its battery status to the network (e.g., network server). When the UAV indicates that its battery cannot guarantee mission success, the network (e.g., network server) could trigger joint RF sensing and energy harvesting for the UAV. In some examples, the UAV can request (e.g., from the network and/or network entity, such as a base station) information regarding the sensing waveform (WF) the UAV is receiving. After the UAV receives the WF information, the UAV may optimize its operation on the WF information (e.g., on the waveform type, carrier frequency, bandwidth). When there is no signaling between the UAV and the network entity (e.g., base station), the UAV may need to estimate these WF parameters (e.g., waveform type, carrier frequency, and bandwidth) to do this operation. When the WF information is in the signaling, the UAV does not need to estimate the WF parameters.

In one or more examples, the UAV can request (e.g., from the network and/or network entity) a time domain window(s) for the joint RF sensing and energy harvesting. In some cases, the UAV may want to charge is battery at a certain time. As such, the UAV can request energy harvesting for a specific time. In some examples, the UAV may report (e.g., to the network and/or network entity) its routine for the mission. The UAV may also report (e.g., to the network and/or network entity) its current location. When the network knows UAV's routine, the network may plan a time domain window for the joint RF sensing and the energy harvesting, at least partly based on the routine for the mission.

In one or more examples, the network (e.g., network server) could indicate (e.g., to the UAV) whether there is at least one network entity (e.g., gNB) that could support high power energy harvesting for the UAV. In some examples, if the network (e.g., network sever) has RF sensing services, the network (e.g., network server) could prioritize to reuse the sensing waveform for energy harvesting. In one or more examples, if the network (e.g., network server) is requested (e.g., by the UAV) to support energy harvesting, the network (e.g., network server) could boost a network entity's (e.g., base station) transmission power for the RF sensing waveform transmission.

In one or more examples, for network energy saving purposes, some network entity (e.g., gNBs) may not support long-duration energy harvesting, or may even cancel their high power transmissions for energy harvesting. As such, a network entity (e.g., gNB) may switch to a lower power transmission for the minimum required signals (e.g., such as single sideband signals). In some examples, the network may indicate these cancelation or changes to the UAV (e.g., UAV UE).

In some examples, the network (e.g., network server) may on-demand request the UAV to change its routine (e.g., trajectory) based on an optimization of the energy harvesting. The network (e.g., network server) may make this request, for example, to make the UAV located closer to the network entity (e.g., gNB), to make the UAV have coverage by the sensing beams, and/or to request the UAV to skip location areas that have weak sensing coverage. In one or more examples, the UAV may not need to adopt the network suggestion. However, the UAV may need to respond to such request (e.g., by responding to the network).

In one or more examples, an issue of remote interference (RI) can occur due to the network entity's (e.g., gNB's) higher transmission power and potential antenna pointing towards the sky. In some cases, the high power transmission can create RI. Generally, a network entity antenna points towards the ground. For the joint sensing and EH, the network entity may point (e.g., beamform) its antenna towards the sky (e.g., point towards a UAV in the sky). This pointing of the antenna towards the sky, instead of towards the ground, can lead to an increase in interference power. In one or more aspects, the systems and techniques provide solutions for the issue of RI. In one or more examples, the remote interference measurement may be reused to enhance the system efficiency.

In current systems, RI is typically detected by a remote network entity (e.g., a victim base station) based on a RAN Information Management (RIM) reference signal (RIM-RS) transmitted by a sensing network entity (e.g., a sensing gNB). In the current standard (e.g., in Release 16 of 3GPP), the RIM-RS is transmitted by a network entity (e.g., gNB).

In one or more aspects, for joint RF sensing and energy harvesting for UAV use cases, cellular systems could reuse the sensing reference signal (RS) for sensing as the RIM-RS. Another RIM-RS will not need to be transmitted and, and such, a time and frequency resource can be conserved. It can be beneficial to reuse the sensing RS as the RIM-RS because the transport node (TN) legacy communication transmission is less likely to point towards the sky with high power and narrow beams and, as such, the legacy RIM-RS measurement may not reflect the RI caused by the sensing RS transmission. It can also be beneficial to reuse the sensing RS as the RIM-RS because the reuse can improve the overall system efficiency by requiring the use of less reference signals.

The sensing reference signal (RS) is primarily designed for RF sensing. In one or more examples, the sensing RS can be designed to be different from the design of the existing RIM-RS. In some examples, the network (e.g., network server or sensing server) can configure the remote network entity (e.g., remote gNB) to detect the sensing RS for RI detection and measurement. For example, the network (e.g., network server or sensing server) can coordinate (e.g., via signaling) with the remote gNB (e.g., the RS gNB) for the remote gNB to detect the sensing RS, instead of the RIM-RS, for RI detection and measurement. In some examples, the network (e.g., network server or sensing server) can provide (e.g., via signaling) to the remote gNB (e.g., the RS gNB) sensing RS information. In one or more examples, the sensing RS parameters along with the time and frequency allocation of the sensing RS can be signaled from the network (e.g., network server or sensing server) to the remote gNBs. In some examples, the network (e.g., network server or sensing server) may schedule a specific measurement gap window for the sensing RS based RI measurement by a remote gNB. As such, during this measurement gap window, the remote gNB can observe the sensing RS to measure the RI.

In one or more aspects, RI measurement-based power control and sensing network entity-based (e.g., by a sensing gNB) soft switching may be employed. In one or more examples, power control of the sensing RS for joint RF sensing and energy harvesting may be performed by the following method. During operation of the method, a remote network entity (e.g., remote gNB) can measure the RI by detecting and measuring the sensing RS. A sensing network entity (e.g., a sensing gNB) is conducting the joint RF sensing and energy harvesting. The sensing gNB is causing the RI interference.

Then, the measured RI can be compared (e.g., by the remote network entity, such as a remote gNB) with a maximum interference threshold. The maximum interference threshold may be defined by the operator of the network entity or one or more Standard documents (e.g., a 3GPP Technical Specification (TS)). The remote network entity (e.g., remote gNB) can then report the measured RI to the network (e.g., network sever). The RI measurement can be forwarded (e.g., by the network, such as the network server) to the sensing gNB. For the power control, the sensing gNB can increase the power of the sensing RS (e.g., to speed up charging the UAV, or to improve the sensing accuracy), if the RI is below the threshold, otherwise the sensing gNB can decrease the power so that the RI does not exceed the threshold. The sensing gNB can stop transmitting the sensing RS, after the UAV enters the coverage of the next sensing gNB.

In one or more examples, with the RI measurement, there can be RI based sensing network entity (e.g., gNB) soft switching for the UAV. For example, when the UAV is traveling through the sensing coverage area of one gNB to another gNB, hard switching (e.g., performed by hardware) may cause some interruption for the sensing service. The use of soft switching, instead of hard switching, can provide continuous service for the joint RF sensing and energy harvesting. In some examples, the UAV can be sensed by multiple neighboring network entities (e.g., gNBs) as long as the RI of the sensing RS for each sensing network entity (e.g., gNB) is below the maximum RI threshold. As long as this requirement is met, multiple network entities (e.g., gNBs) can conduct multiple gNB based sensing. In one or more examples, the network entity (e.g., gNB) can stop transmitting the sensing signal, if the minimum required power of the sensing signal exceeds the maximum RI threshold.

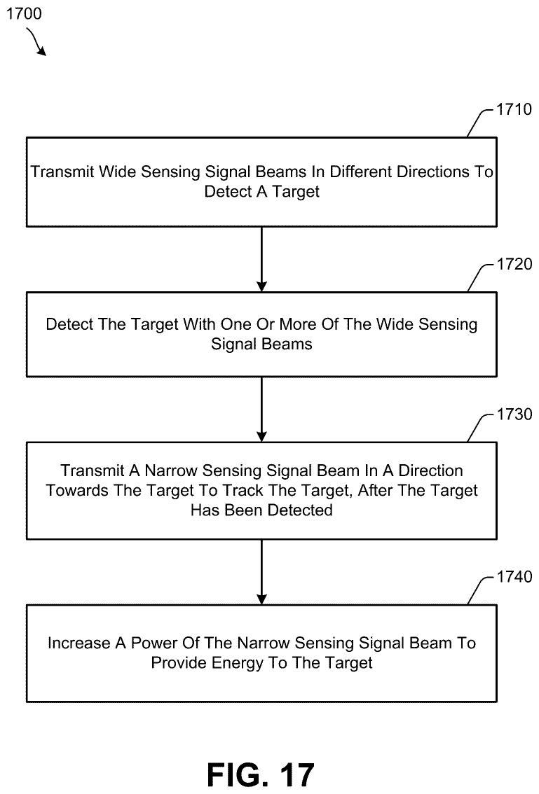

FIG. 17 is a flow chart illustrating an example of a process 1700 for wireless communications utilizing methods for joint RF sensing and energy harvesting for UAV use cases. The process 1700 can be performed by a first network entity (e.g., a base station, such as a gNB, a server, or other type of network entity), a portion of the first network entity (e.g., one or more of a CU, DU, RU, and/or other portion of a network entity having a disaggregated architecture), or a component or system (e.g., a chipset) of the first network entity. The operations of the process 1700 may be implemented as software components that are executed and run on one or more processors (e.g., processor 2110 of FIG. 21 or other processor(s)). Further, the transmission and reception of signals by the wireless communications device in the process 1700 may be enabled, for example, by one or more antennas and/or one or more transceivers (e.g., wireless transceiver(s)).

At block 1710, the first network entity (or component thereof) can transmit wide sensing signal beams in different directions to detect a target. In some cases, each of the wide sensing signal beams has a larger beamwidth than a beamwidth of the narrow sensing signal beam. Referring to FIG. 13 as an illustrative example, the network entity 1310 can transmit RF sensing signal beams 1315a, 1315b, 1315b (e.g., each with a wide beamwidth) in different directions towards the target 1320 (e.g., drone).

At block 1720, the first network entity (or component thereof) can detect the target with one or more of the wide sensing signal beams. In some cases, the first network entity (or component thereof) can identify the target as a particular type of device, such as an unmanned aerial vehicle (UAV). At block 1730, the first network entity (or component thereof) can transmit a narrow sensing signal beam in a direction towards the target to track the target, after the target has been detected. Referring again to FIG. 13 as an illustrative example, once the target is detected, the network entity 1310 can track the target 1320 by transmitting (e.g., radiating) a RF sensing signal beam 1415 (e.g., with a narrow beamwidth) in a focused direction towards the target 1320.

At block 1740, the first network entity (or component thereof) can increase a power of the narrow sensing signal beam to provide energy to the target. In some aspects, the first network entity (or component thereof) can tune hardware of the first network entity for impedance matching to provide the energy to the target. For instance, the first network entity (or component thereof) can tune the hardware based on a carrier frequency of the wide sensing signal beams and/or the narrow sensing signal beam. Referring to FIG. 14 as one illustrative example, if the network entity 1410 identifies that the target 1420 is a UAV, the network entity 1410 can increase the transmission power from the network entity 1410 (e.g., increase transmission power of the narrow RF sensing signal beam 1415) for the RF sensing. For instance, the network entity 1410 can increase the transmission power even if the network entity 1410 has already been able to track the target 1420 with high signal quality without needing to increase the signal power to track the target 1420.

In some cases, the first network entity (or component thereof) can report (e.g., by transmitting a report), to a second network entity, location information for the target. For instance, the first network entity (or component thereof) can transmit a report including the location information for the target to the second network entity. In some aspects, the location information includes a range, speed, angle, coordinates, altitude of the target, any combination thereof, and/or other information. In some cases, the first network entity (or component thereof) can report, to the second network entity, a target identification (ID) for the target. For instance, the first network entity (or component thereof) can transmit a report including the target ID for the target to the second network entity. In some aspects, the first network entity (or component thereof) can report the location information and the target ID for the target (e.g., by transmitting a report with the location information and the target ID).

In some aspects, the first network entity (or component thereof) can receive, from the second network entity, a request to track and provide energy to another target (e.g., another unmanned aerial vehicle or other target device). In some cases, the first network entity (or component thereof) can receive, from the second network entity, a request for power control for the narrow sensing signal beam. In some aspects, the request for power control includes information requesting one of an increase or a decrease in the power of the narrow sensing signal beam. In some examples, the request for power control includes information requesting a minimum duration of time for transmission of the power of the narrow sensing signal beam.

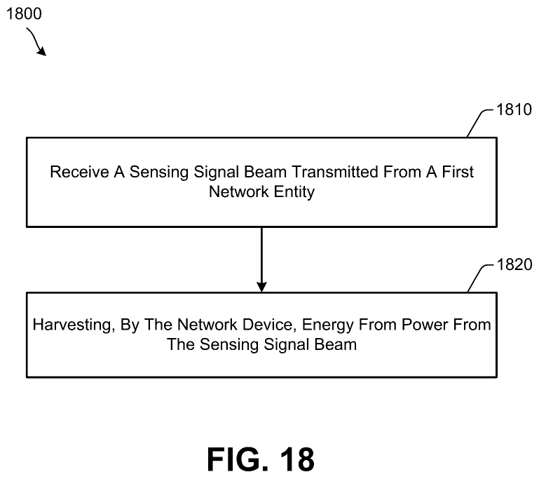

FIG. 18 is a flow chart illustrating an example of a process 1800 for wireless communications utilizing methods for joint RF sensing and energy harvesting for UAV use cases. The process 1800 can be performed by a network device or a component or system (e.g., a chipset) of the network device. The network device may be a UE, such as an unmanned aerial vehicle (UAV), a mobile device (e.g., a mobile phone), a vehicle, a wearable device (e.g., a network-connected watch or other wearable device), an extended reality (XR) device (e.g., a virtual reality (VR) or augmented reality (AR) headset or glasses), and/or other type of UE. The operations of the process 1800 may be implemented as software components that are executed and run on one or more processors (e.g., processor 2110 of FIG. 21 or other processor(s)). Further, the transmission and reception of signals by the wireless communications device in the process 1800 may be enabled, for example, by one or more antennas and/or one or more transceivers (e.g., wireless transceiver(s)).

At block 1810, the network device (or component thereof) can receive a sensing signal beam transmitted from a first network entity. In some aspects, the power of the sensing signal beam increases over time. In some cases, the first network entity is a base station (e.g., a gNB).

At block 1820, the network device (or component thereof) can harvest energy from power from the sensing signal beam. In some cases, the network device (or component thereof) can report, to a second network entity (e.g., a network server or other network entity), a battery status of the network device, a route for a mission of the network device, a current location of the network device, any combination thereof, and/or other information associated with the network device. In some aspects, the network device (or component thereof) can receive, from the second network entity, a request for a change in the route for the mission of the network device. In some cases, the network device (or component thereof) can change the route of the network device based on the request.

In some aspects, the network device (or component thereof) can transmit, to a second network entity, a request for sensing waveform information and/or a time domain window for harvesting the energy from the power of the sensing signal beam. For instance, the network device (e.g., unmanned aerial vehicle or other network device) can request (e.g., from the network entity) a time domain window(s) for joint RF sensing and energy harvesting. In one illustrative example, the network device may want to charge is battery at a certain time and can thus request energy harvesting for a specific time.

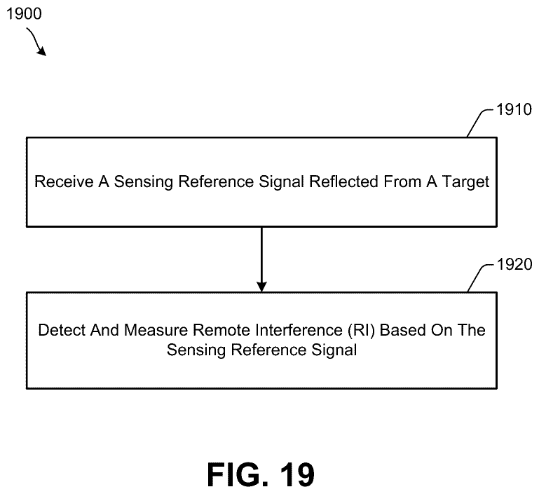

FIG. 19 is a flow chart illustrating an example of a process 1900 for wireless communications utilizing methods for joint RF sensing and energy harvesting for UAV use cases. The process 1900 can be performed by a network entity (e.g., a remote base station, such as a gNB, a server, or other type of network entity), a portion of a network entity (e.g., one or more of a CU, DU, RU, and/or other portion of a network entity having a disaggregated architecture), or a component or system (e.g., a chipset) of the network entity. The operations of the process 1900 may be implemented as software components that are executed and run on one or more processors (e.g., processor 2110 of FIG. 21 or other processor(s)). Further, the transmission and reception of signals by the wireless communications device in the process 1900 may be enabled, for example, by one or more antennas and/or one or more transceivers (e.g., wireless transceiver(s)).

At block 1910, the network entity (or component thereof) can receive a sensing reference signal reflected from a target (e.g., an unmanned aerial vehicle or other target device).

At block 1920, the network entity (or component thereof) can detect and measure remote interference (RI) based on the sensing reference signal. In some aspects, the network entity (or component thereof) can receive, from a second network entity (e.g., a network server or other network entity), a request to detect and measure the sensing reference signal for detecting and measuring the RI. In some aspects, the network entity (or component thereof) can receive, from the second network entity, parameters of the sensing reference signal. In some examples, the network entity (or component thereof) can receive, from the second network entity, a time and frequency allocation of the sensing reference signal.

In some aspects, the network entity (or component thereof) can compare measurements of the RI with a maximum interference threshold. In some cases, the maximum interference threshold is defined by standards (e.g., a 3GPP Technical Specification (TS)) or by an operator of the first network entity. In some examples, the network entity (or component thereof) can report, to the second network entity, the measurements of the RI. In some examples, second network entity can transmit (e.g., forward) the RI measurement to a sensing network entity (e.g., a sensing gNB). In some cases, a power of the sensing reference signal is based on the measurements of the RI with respect to the maximum interference threshold (e.g., based on comparing the measurements of the RI with the maximum interference threshold). In some cases, the maximum interference threshold may be defined by the operator of the network entity or in one or more Standard documents (e.g., a 3GPP TS). A sensing network entity (e.g., a sensing gNB) can perform power control, for example by increasing the power of the sensing RS (e.g., to speed up charging the UAV, or to improve the sensing accuracy) if the RI is below the threshold, or decreasing the power so that the RI does not exceed the threshold. In some aspects, the sensing gNB can stop transmitting the sensing RS, after the target (e.g., the unmanned aerial vehicle) enters a coverage of a next sensing gNB.

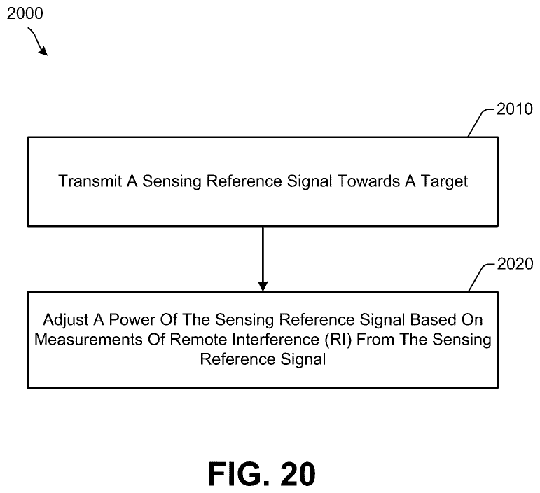

FIG. 20 is a flow chart illustrating an example of a process 2000 for wireless communications utilizing methods for joint RF sensing and energy harvesting for UAV use cases. The process 2000 can be performed by a network entity (e.g., a sensing base station, such as a gNB, a server, or other type of network entity), a portion of a network entity (e.g., one or more of a CU, DU, RU, and/or other portion of a network entity having a disaggregated architecture), or a component or system (e.g., a chipset) of the network entity. The operations of the process 2000 may be implemented as software components that are executed and run on one or more processors (e.g., processor 2110 of FIG. 21 or other processor(s)). Further, the transmission and reception of signals by the wireless communications device in the process 2000 may be enabled, for example, by one or more antennas and/or one or more transceivers (e.g., wireless transceiver(s)).

At block 2010, the network entity (or component thereof) can transmit a sensing reference signal towards a target (e.g., an unmanned aerial vehicle or other target device). For instance, the network entity (e.g., operating as a sensing network entity such as a sensing gNB) can conduct the joint RF sensing and energy harvesting. The sensing gNB can cause the remote interference (RI) interference based on transmitting the sensing reference signal. For instance, a remote network entity (e.g., remote gNB) can measure the RI by detecting and measuring the sensing RS. The measured RI can be compared (e.g., by the remote network entity, such as a remote gNB) with a maximum interference threshold. As noted previously, the maximum interference threshold may be defined by the operator of the network entity or in one or more Standard documents (e.g., a 3GPP TS). The remote network entity (e.g., remote gNB) can then report the measured RI to the network (e.g., to a network sever). The RI measurement can be forwarded (e.g., by the network, such as the network server) to the network entity (e.g., operating as a sensing network entity, such as a sensing gNB).

At block 2020, the network entity (or component thereof) can adjust a power of the sensing reference signal based on measurements of remote interference (RI) from the sensing reference signal. In one illustrative example, if the RI is below the threshold, the network entity (e.g., operating as a sensing network entity) can increase the power of the sensing RS (e.g., to speed up charging the UAV, or to improve the sensing accuracy). In another example, if the RI is greater than the threshold, the network entity can decrease the power so that the RI does not exceed the threshold. In some cases, the network entity can stop transmitting the sensing RS, such as after the target (e.g., the unmanned aerial vehicle or other target device) enters the coverage of a different network entity (e.g., a different sensing gNB).

FIG. 21 is a block diagram illustrating an example of a computing system 2100, which may be employed by the disclosed systems and techniques for joint RF sensing and energy harvesting for UAV use cases. In particular, FIG. 21 illustrates an example of computing system 2100, which can be, for example, any computing device making up internal computing system, a remote computing system, a camera, or any component thereof in which the components of the system are in communication with each other using connection 2105. Connection 2105 can be a physical connection using a bus, or a direct connection into processor 2110, such as in a chipset architecture. Connection 2105 can also be a virtual connection, networked connection, or logical connection.

In some aspects, computing system 2100 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 2100 includes at least one processing unit (CPU or processor) 2110 and connection 2105 that communicatively couples various system components including system memory 2115, such as read-only memory (ROM) 2120 and random access memory (RAM) 2125 to processor 2110. Computing system 2100 can include a cache 2112 of high-speed memory connected directly with, in close proximity to, or integrated as part of processor 2110.

Processor 2110 can include any general purpose processor and a hardware service or software service, such as services 2132, 2134, and 2136 stored in storage device 2130, configured to control processor 2110 as well as a special-purpose processor where software instructions are incorporated into the actual processor design. Processor 2110 may essentially be a completely self-contained computing system, containing multiple cores or processors, a bus, memory controller, cache, etc. A multi-core processor may be symmetric or asymmetric.

To enable user interaction, computing system 2100 includes an input device 2145, which can represent any number of input mechanisms, such as a microphone for speech, a touch-sensitive screen for gesture or graphical input, keyboard, mouse, motion input, speech, etc. Computing system 2100 can also include output device 2135, which can be one or more of a number of output mechanisms. In some instances, multimodal systems can enable a user to provide multiple types of input/output to communicate with computing system 2100.

Computing system 2100 can include communications interface 2140, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug. 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 2140 may also include one or more range sensors (e.g., LIDAR sensors, laser range finders, RF radars, ultrasonic sensors, and infrared (IR) sensors) configured to collect data and provide measurements to processor 2110, whereby processor 2110 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 2140 may also include one or more Global Navigation Satellite System (GNSS) receivers or transceivers that are used to determine a location of the computing system 2100 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 2130 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), crasable programmable read-only memory (EPROM), electrically crasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 2130 can include software services, servers, services, etc., that when the code that defines such software is executed by the processor 2110, it causes the system to perform a function. In some aspects, a hardware service that performs a particular function can include the software component stored in a computer-readable medium in connection with the necessary hardware components, such as processor 2110, connection 2105, output device 2135, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative aspects of the disclosure include:

Aspect 1. A first network entity for wireless communications, the first network entity comprising: at least one memory; and at least one processor coupled to the at least one memory and configured to: receive a sensing reference signal reflected from a target; and detect and measure remote interference (RI) based on the sensing reference signal.

Aspect 2. The first network entity of Aspect 1, wherein the first network entity is a remote base station.

Aspect 3. The first network entity of any one of Aspects 1 or 2, wherein the at least one processor is configured to receive, from a second network entity, a request to detect and measure the sensing reference signal for detecting and measuring the RI.

Aspect 4. The first network entity of Aspect 3, wherein the second network entity is a network server.

Aspect 5. The first network entity of any one of Aspects 3 or 4, wherein the at least one processor is configured to receive, from the second network entity, parameters of the sensing reference signal.

Aspect 6. The first network entity of any one of Aspects 3 to 5, wherein the at least one processor is configured to receive, from the second network entity, a time and frequency allocation of the sensing reference signal.

Aspect 7. The first network entity of any one of Aspects 1 to 6, wherein the at least one processor is configured to compare measurements of the RI with a maximum interference threshold.

Aspect 8. The first network entity of Aspect 7, wherein the maximum interference threshold is defined by one of standards or by an operator of the first network entity.

Aspect 9. The first network entity of any one of Aspects 7 or 8, wherein the at least one processor is configured to report, to a second network entity, the measurements of the RI.

Aspect 10. The first network entity of any one of Aspects 7 to 9, wherein a power of the sensing reference signal is based on the measurements of the RI with respect to a maximum interference threshold.

Aspect 11. A method for wireless communications at a first network entity, the method comprising: receiving, by the first network entity, a sensing reference signal reflected from a target; and detecting and measuring, by the first network entity, remote interference (RI) based on the sensing reference signal.

Aspect 12. The method of Aspect 11, wherein the first network entity is a remote base station.

Aspect 13. The method of any one of Aspects 11 or 12, further comprising receiving, by the first network entity from a second network entity, a request to detect and measure the sensing reference signal for detecting and measuring the RI.

Aspect 14. The method of Aspect 13, wherein the second network entity is a network server.

Aspect 15. The method of any one of Aspects 13 or 14, further comprising receiving, by the first network entity from the second network entity, parameters of the sensing reference signal.

Aspect 16. The method of any one of Aspects 13 to 15, further comprising receiving, by the first network entity from the second network entity, a time and frequency allocation of the sensing reference signal.

Aspect 17. The method of any one of Aspects 11 to 16, further comprising comparing, by the first network entity, measurements of the RI with a maximum interference threshold.

Aspect 18. The method of Aspect 17, wherein the maximum interference threshold is defined by one of standards or by an operator of the first network entity.

Aspect 19. The method of any one of Aspects 17 or 18, further comprising reporting, by the first network entity to a second network entity, the measurements of the RI.

Aspect 20. The method of any one of Aspects 17 to 19, wherein a power of the sensing reference signal is based on the measurements of the RI with respect to a maximum interference threshold.

Aspect 21. A network entity for wireless communications, the network entity comprising: at least one memory; and at least one processor coupled to the at least one memory and configured to: transmit a sensing reference signal towards a target; and adjust a power of the sensing reference signal based on measurements of remote interference (RI) from the sensing reference signal.

Aspect 22. The network entity of Aspect 27, wherein the network entity is a sensing base station.

Aspect 23. A method for wireless communications at a network entity, the method comprising: transmitting, by the network entity, a sensing reference signal towards a target; and adjusting, by the network entity, a power of the sensing reference signal based on measurements of remote interference (RI) from the sensing reference signal.

Aspect 24. The method of Aspect 29, wherein the network entity is a sensing base station.

Aspect 43. A non-transitory computer-readable medium having stored thereon instructions that, when executed by at least one processor, cause the at least one processor to perform operation according to any of Aspects 11 to 20.

Aspect 44. An apparatus for wireless communications, comprising one or more means for performing operations according to any of Aspects 11 to 20.

Aspect 45. A non-transitory computer-readable medium having stored thereon instructions that, when executed by at least one processor, cause the at least one processor to perform operations according to any of Aspects 23 or 24.

Aspect 46. An apparatus for wireless communications, comprising one or more means for performing operations according to any of Aspects 23 or 24.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. A first network entity for wireless communications, the first network entity comprising:
at least one memory; and
at least one processor coupled to the at least one memory and configured to:
receive a sensing reference signal reflected from a target; and
detect and measure remote interference (RI) based on the sensing reference signal.

2. The first network entity of claim 1, wherein the first network entity is a remote base station.

3. The first network entity of claim 1, wherein the at least one processor is configured to receive, from a second network entity, a request to detect and measure the sensing reference signal for detecting and measuring the RI.

4. The first network entity of claim 3, wherein the second network entity is a network server.

5. The first network entity of claim 3, wherein the at least one processor is configured to receive, from the second network entity, parameters of the sensing reference signal.

6. The first network entity of claim 3, wherein the at least one processor is configured to receive, from the second network entity, a time and frequency allocation of the sensing reference signal.

7. The first network entity of claim 1, wherein the at least one processor is configured to compare measurements of the RI with a maximum interference threshold.

8. The first network entity of claim 7, wherein the maximum interference threshold is defined by one of standards or by an operator of the first network entity.

9. The first network entity of claim 7, wherein the at least one processor is configured to report, to a second network entity, the measurements of the RI.

10. The first network entity of claim 7, wherein a power of the sensing reference signal is based on the measurements of the RI with respect to a maximum interference threshold.

11. A method for wireless communications at a first network entity, the method comprising:
receiving, by the first network entity, a sensing reference signal reflected from a target; and
detecting and measuring, by the first network entity, remote interference (RI) based on the sensing reference signal.

12. The method of claim 11, wherein the first network entity is a remote base station.

13. The method of claim 11, further comprising receiving, by the first network entity from a second network entity, a request to detect and measure the sensing reference signal for detecting and measuring the RI.

14. The method of claim 13, wherein the second network entity is a network server.

15. The method of claim 13, further comprising receiving, by the first network entity from the second network entity, parameters of the sensing reference signal.

16. The method of claim 13, further comprising receiving, by the first network entity from the second network entity, a time and frequency allocation of the sensing reference signal.

17. The method of claim 11, further comprising comparing, by the first network entity, measurements of the RI with a maximum interference threshold.

18. The method of claim 17, wherein the maximum interference threshold is defined by one of standards or by an operator of the first network entity.

19. The method of claim 17, further comprising reporting, by the first network entity to a second network entity, the measurements of the RI.

20. The method of claim 17, wherein a power of the sensing reference signal is based on the measurements of the RI with respect to a maximum interference threshold.

21. A non-transitory computer-readable medium having stored thereon instructions that, when executed by at least one processor, cause the at least one processor to:
receive a sensing reference signal reflected from a target; and
detect and measure remote interference (RI) based on the sensing reference signal.

22. The non-transitory computer-readable medium of claim 21, wherein the instructions, when executed by the at least one processor, cause the at least one processor to receive, from a second network entity, a request to detect and measure the sensing reference signal for detecting and measuring the RI.

23. The non-transitory computer-readable medium of claim 21, wherein the instructions, when executed by the at least one processor, cause the at least one processor to receive, from a second network entity, parameters of the sensing reference signal.

24. The non-transitory computer-readable medium of claim 21, wherein the instructions, when executed by the at least one processor, cause the at least one processor to receive, from a second network entity, a time and frequency allocation of the sensing reference signal.

25. The non-transitory computer-readable medium of claim 21, wherein the instructions, when executed by the at least one processor, cause the at least one processor to compare measurements of the RI with a maximum interference threshold.

26. The non-transitory computer-readable medium of claim 25, wherein the instructions, when executed by the at least one processor, cause the at least one processor to report, to a second network entity, the measurements of the RI.

27. A network entity for wireless communications, the network entity comprising:
at least one memory; and
at least one processor coupled to the at least one memory and configured to:
transmit a sensing reference signal towards a target; and
adjust a power of the sensing reference signal based on measurements of remote interference (RI) from the sensing reference signal.

28. The network entity of claim 27, wherein the network entity is a sensing base station.

29. A method for wireless communications at a network entity, the method comprising:
transmitting, by the network entity, a sensing reference signal towards a target; and
adjusting, by the network entity, a power of the sensing reference signal based on measurements of remote interference (RI) from the sensing reference signal.

30. The method of claim 29, wherein the network entity is a sensing base station.
